(19) United States
(12) Patent Application Publication
(10) Pub. No.: US 2025/0214870 A1
(43) Pub. Date: Jul. 3, 2025

(54) SYSTEMS AND METHODS FOR RESIN BREAKTHROUGH IDENTIFICATION USING ION-SELECTIVE ELECTRODES

(71) Applicant: Pentair, Inc., Minneapolis, MN (US)

(72) Inventors: Prerna Bansal, Noida (IN); Ajit Tulo, Grater Noida (IN); Anuj Saini, Ghaziabad (IN)

(21) Appl. No.: 19/002,269

(22) Filed: Dec. 26, 2024

Related U.S. Application Data
(60) Provisional application No. 63/615,172, filed on Dec. 27, 2023.

(51) Int. Cl. C02F 1/42; C02F 5/10; C02F 101/20

(52) U.S. Cl. CPC C02F 1/42; C02F 5/10; C02F 2001/425; C02F 2101/203; C02F 2101/206; C02F 2201/005; C02F 2209/055; C02F 2209/40

(57) ABSTRACT

A water treatment system including a treatment tank, a probe, and a controller is provided. The treatment tank includes an inlet, an outlet, and a resin. The inlet is in fluid communication with a source of untreated water, and the outlet is designed to provide a treated water from the treatment tank. The resin retained within the treatment tank is designed to generate treated water. The untreated water is imparted with a first concentration of positively charged ions, while the treated water is imparted with a second concentration of positively charged ions. The probe is in fluid communication with the outlet and is designed to determine a value of the second concentration of positively charged ions at a first time period. The controller is in communication with the probe and is designed to determine a rate of change associated with measurements of the second concentration of positively charged ions.

### CROSS-REFERENCE TO RELATED APPLICATIONS

This application claims priority to U.S. Provisional Patent Application Ser. No. 63/615,172, filed on Dec. 27, 2023, entitled “SLOPE BASED BREAKTHROUGH IDENTIFICATION USING ION-SELECTIVE ELECTRODES,” currently pending, the entire disclosure of which is incorporated herein by reference.

### FIELD OF DISCLOSURE

The present disclosure relates to systems and methods for identifying resin-bed breakthrough in water softening systems. More particularly, the present disclosure relates to systems and methods for identifying resin-bed breakthrough in a water softener system using an ion-selective electrode.

### BACKGROUND

“Hard water” from wells or other natural sources often contains divalent and/or trivalent ions which have leached from mineral deposits in the earth. Water softeners are typically used to “soften” or treat the hard water by removing the divalent and trivalent ions from the hard water. Commonly, water softeners comprise an ion exchange system provided as a tank including a resin bed through which the untreated, hard water flows. As the untreated water flows through the resin bed, undesirable minerals (e.g., calcium, magnesium) and other impurities may be removed from the untreated water to create a treated, softened water.

The capacity of the resin bed to absorb minerals and impurities is finite. When the capacity of the resin bed is substantially depleted, it becomes necessary to regenerate the resin bed by flushing it with a regenerate, typically a solution of sodium chloride or potassium chloride (also referred to as brine). If the resin bed is not regenerated, divalent and trivalent ions may pass through the water softener substantially unimpeded, a process characterized as “resin breakthrough.”

Early regeneration methods relied on manual monitoring of the resin beds to determine when treatment capacity of the resin bed has been exceeded. Manual monitoring is extremely inconvenient for users, as manual monitoring requires the users to constantly monitor their water softening systems, increasing the risk that resin breakthrough will be undiscovered by the users. More recently, water softener control systems also have been provided with a mechanical clock that initiates resin regeneration periodically. However, regenerating the resin bed at fixed intervals may result in situations where the resin bed is regenerated too often or not often enough, depending on water usage amounts.

Other types of control systems measure the resin breakthrough directly using total dissolved solids (TDS) or conductivity sensors to measure the electrical conductivity of all the ions in the resin bed, the sensors positioned in at least two different, spaced-apart locations. Disadvantages of such systems include incorrect determination of resin bed exhaustion, resulting in regeneration that happens too infrequently or too often. In addition, such systems require multiple electrodes or probes, which represents a significant expense for the users.

Thus, there is a need for improved systems and methods for accurately identifying near breakthrough and real-time breakthrough of the resin bed, which are effective, easy to implement and manufacture, and cost effective.

### SUMMARY

In some aspects, a water treatment system including a treatment tank, a probe, and a controller is provided. The treatment tank is provided in the form of an inlet, an outlet, and a resin. The inlet is in fluid communication with a source of untreated water, and the outlet is designed to provide a treated water from the treatment tank. The resin is retained within the treatment tank that is designed to generate treated water. The untreated water is imparted with a first concentration of positively charged ions, while the treated water is imparted with a second concentration of positively charged ions. The probe is in fluid communication with the outlet of the treatment tank and is designed to determine a value of the second concentration of positively charged ions at a first time period. The controller is in communication with the probe and is designed to determine a rate of change associated with measurements of the second concentration of positively charged ions.

In some instances, the controller determines a resin breakthrough status by assessing whether the rate of change of the second concentration of positively charged ions is above, below, or substantially equal to a first threshold value.

In some such instances, the controller initiates a regeneration cycle at a second time period after determining that resin breakthrough has occurred.

In other instances, the positively charged ions are selected from the group consisting of calcium ions, magnesium ions, barium ions, aluminum ions, strontium ions, iron ions, zinc ions, and manganese ions.

In yet other instances, the probe is an ion-selective probe and measures the concentration of positively charged ions in the treated water at regular intervals, whereby the regular intervals are determined by a water volume flowing through the water treatment system.

In some instances, the controller is further designed to determine a slope utilizing the first and second concentrations of positive ions, and determine if the slope is above, substantially equal to, or below a threshold value to determine a subsequent action of the water treatment system.

In other instances, no action is taken by the water treatment system when the slope is below the threshold value. Alternatively, an alert is created when the slope is near the threshold value. Otherwise, the water treatment system initiates regeneration when the slope is at or above the threshold value.

In other aspects, a water softener system is provided in the form of a water-treatment vessel, an outlet conduit, an ion-selective probe, and a controller. The water-treatment vessel is designed to remove minerals from water passing through the water-treatment vessel to generate a treated water when the system operates in a service mode. The outlet conduit is in fluid communication with the water-treatment vessel and the ion-selective probe. The ion-selective probe is designed to measure at least a first ion concentration in the treated water at a first time period and a second ion concentration in the treated water at a second time period. The controller is in communication with the ion-selective probe and is designed to determine whether resin bed breakthrough has occurred based at least partially on the first ion concentration and the second ion concentration.

In some instances, the ion-selective probe determines a plurality of ion concentrations, and a flow sensor is in fluid communication with the water-treatment vessel. The flow sensor monitors a volume of water flowing through the water softener system. The controller determines a slope using the plurality of ion concentrations and the volume of water to determine whether resin bed breakthrough has occurred. In some such instances, the flow sensor may be in communication with the controller.

In some such instances, upon determining that resin bed breakthrough has occurred, the controller initiates a regeneration cycle.

In other instances, the controller initiates a regeneration cycle at a third time period upon determining that resin bed breakthrough has occurred, and the regeneration cycle includes providing a brine solution to the resin bed.

In some instances, the controller is further designed to initiate a standby mode in which untreated water is provided to the outlet conduit.

In other instances, the ion-selective probe measures a concentration of positively charged ions in the treated water at regular intervals, whereby the regular intervals are determined by a volume of water flowing through the water-treatment vessel.

In yet other aspects, a method for determining resin breakthrough of a water softener includes the steps of placing a first ion-selective probe and a second ion-selective probe in fluid communication with a treated water stream generated by the water softener, determining a concentration of the positive monovalent ions and a concentration of positive divalent ions in the treated water stream, and providing a controller in communication with the first ion-selective probe and the second ion-selective probe. Each of the first ion-selective probe and the second ion-selective probe is in fluid communication with the treated water stream generated by the water softener system. The controller determines an ion differential based on the concentration of the positive monovalent ions and the concentration of positive divalent ions and uses the ion differential and a threshold value to determine a subsequent action of the water softener.

In some instances, the positive monovalent ions are selected from the group consisting of sodium ions and potassium ions.

In other instances, the method includes taking no action when the ion differential is above the threshold value, generating an alert when the ion differential is near the threshold value, and regenerating the water softener when the ion differential is at or below the threshold value.

In yet other instances, the method includes providing a second and a third threshold value, taking no action when the ion differential exceeds the second threshold value and the third threshold value, creating an alert when the ion differential is at or below the second threshold value and above the third threshold value, and regenerating a resin bed of the water softener when the ion differential is at or below the second threshold value and the third threshold value.

In some such instances, the regeneration step includes at least one of a brining step, a rinsing step, and a backwash step.

In some instances, the method also includes dosing a brine solution when the ion differential is at or below the threshold value, wherein the brine solution includes sodium ions.

In other instances, the threshold value corresponds to a current of no more than about 40 mV.

### DESCRIPTION OF THE DRAWINGS

FIG. 1A is a schematic diagram depicting a home water system including a water softener;

FIG. 1B is a schematic representation of the water softener of FIG. 1A;

FIG. 2 is a schematic representation of a water softener system;

FIG. 3 is a front isometric view of another water softener system;

FIG. 4 is a rear isometric view of the water softener of FIG. 2;

FIG. 5A is a schematic representation of a single-unit water softening system;

FIG. 5B is a schematic view of a multi-unit water softening system;

FIG. 6 is a front isometric view of a water quality monitor;

FIG. 7 is a schematic view of another water softening system including a brine tank having a brine well;

FIG. 8 is a front isometric view of the brine well of FIG. 7;

FIG. 9 illustrates a graph depicting calcium and sodium ion concentrations measured versus a volume of water, the water imparted with a hardness value of 23 grains;

FIG. 10 illustrates a graph showing calcium and sodium ion concentrations versus a volume of water, the water imparted with a hardness value of 15 grains;

FIG. 11 illustrates a graph showing a calcium ion concentration versus a volume of water, the water imparted with a hardness value of 23 grains;

FIG. 12 illustrates a graph showing a first slope, a second slope, and a third slope determined using a concentration of calcium ions versus a volume of water, the water imparted with a hardness value of 23 grains;

FIG. 13 illustrates a graph showing a calcium ion concentration versus a volume of water, the water imparted with a hardness value of 15 grains;

FIG. 14 illustrates a graph showing a first slope, a second slope, and a third slope determined using a concentration of sodium ions versus a volume of water;

FIG. 15 illustrates a flow diagram depicting a method of determining whether to regenerate a resin bed of a water softener system; and

FIG. 16 illustrates a flow diagram depicting a method of assessing inlet conduit water hardness based on a slope measurement.

### DETAILED DESCRIPTION

Before any aspects of the disclosure are explained in detail, it is to be understood that the disclosure is not limited in its application to the details of construction and the arrangement of components set forth in the following description or illustrated in the following drawings. The disclosure is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use aspects of the disclosure. Various modifications to the illustrated aspects will be readily apparent to those skilled in the art, and the generic principles herein can be applied to other aspects and applications without departing from aspects of the disclosure. Thus, aspects of the disclosure are not intended to be limited to aspects shown but are to be accorded the widest scope consistent with the principles and features disclosed herein. The figures, which are not necessarily to scale, depict selected aspects and are not intended to limit the scope of aspects of the disclosure. Skilled artisans will recognize the examples provided herein have many useful alternatives and fall within the scope of aspects of the disclosure.

According to the teachings herein, a water treatment system and methods of using the water treatment system are provided. The water treatment system is provided in the form of a softening tank including a resin bed and a brine tank. The resin bed may be configured to remove minerals including calcium and magnesium ions and, optionally, other impurities from water provided to the softening tank via an inlet conduit. The treated water produced by the softening tank may then be provided to an outlet conduit and ultimately to an end user. The system may be configured to remove divalent and/or trivalent ions (e.g., calcium ions and magnesium ions) from hard water (e.g., water with a grain value of at least about 1 grain, equivalent to approximately 17.1 ppm) from various sources. In various instances, the water treatment system is provided as a water softener system.

In addition, the system may include one or more probes designed to monitor the concentrations of monovalent, divalent, and/or trivalent ions over time. The probes may be provided in the form of an ion-selective probes or electrodes that are in fluid communication with an outlet conduit of the softening tank. The ion-selective probes may be used to determine a concentration of ions in the treated water, which in turn may help determine when resin breakthrough has occurred. In various instances, only a single ion-selective probe is provided in the water treatment system.

Ion-selective probes are electroanalytical sensors whose signals depend on the activities of ions in a solution. Ion-selective probes typically contain a thin membrane across which only the ion targeted for measurement is transported. The sensor measures electrical conductivity as a potential difference generated by the ions that pass through the membrane. Thus, the quantitative output value of an electrode may be provided in units of either concentration or current. In some instances, the ion-selective probe may provide data to a controller associated with the water treatment system, and the controller, using the data, may determine when resin breakthrough has occurred or is imminent.

In some instances, the system described herein may determine resin breakthrough using only a single ion-selective probe. The information obtained from the single ion-selective probe may be analyzed by a controller to determine when resin bed breakthrough has occurred. The ion-selective probe may measure, detect, or determine a concentration of divalent ions and/or trivalent ions in the treated water at regular or predetermined intervals defined by an amount or volume of water flowing through the water treatment system. Upon identifying resin breakthrough or an imminent risk of breakthrough, the controller may alert a user to regenerate the resin of the water treatment system and/or the controller may direct the system to initiate regeneration of the resin.

In some instances, the system described herein may determine resin breakthrough using at least two ion-selective probes (e.g., a first ion-selective probe and a second ion-selective probe). The first ion-selective probe may measure a concentration of monovalent ions in the water and the second ion-selective probe may measure a concentration of divalent and/or trivalent ions in the water. The controller may determine an ion differential using the information obtained from the at least two ion-selective probes (e.g., a difference in the concentrations of the monovalent ions and the divalent and/or trivalent ions) to determine when resin bed breakthrough has occurred. In certain cases, the at least two ion-selective probes may measure or determine an ion differential based on the concentration of divalent and/or trivalent ions and monovalent ions at regular or predetermined intervals defined by an amount or volume of water flowing through the water treatment system.

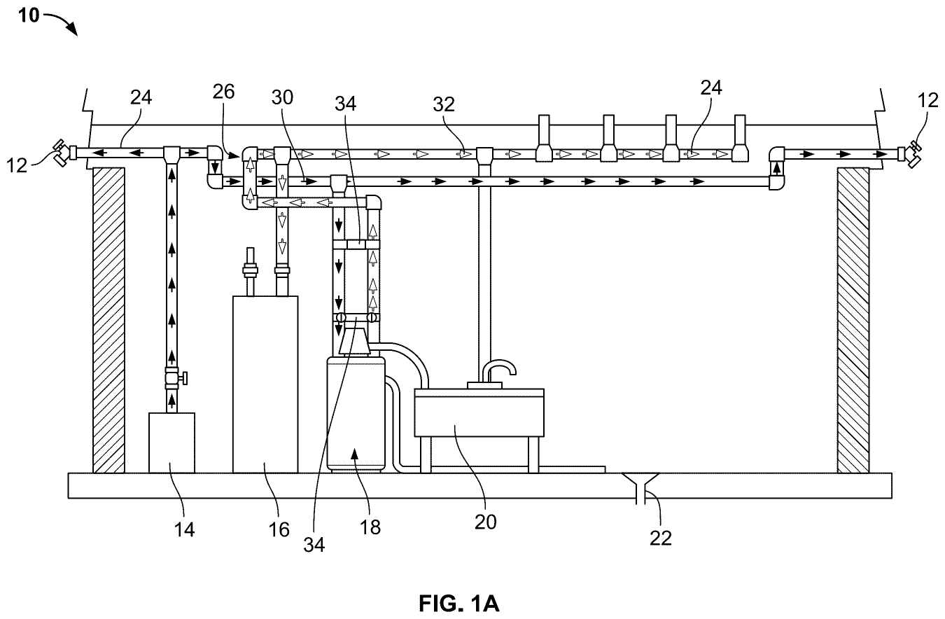

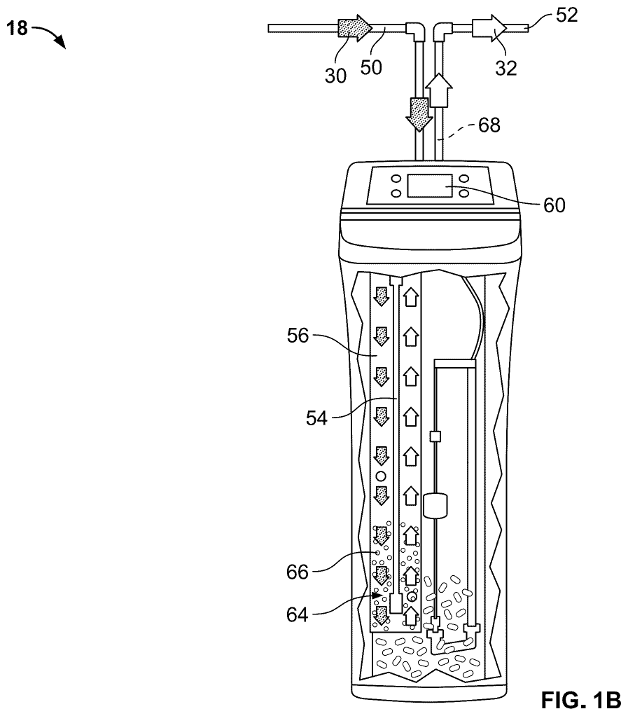

Referring now to FIG. 1A, a home water system 10 may be provided in the form of one or more faucets 12, a pump 14, a water heater 16, a water softener system 18, a laundry system 20, a drain 22, and one or more outlets 24. The aforementioned components of the home water system may be placed in fluid communication via one or more conduits 26. The home water system 10 may be designed to supply water to various home appliances on demand. In addition, the home water system 10 may be designed to supply treated or softened water to a user when the home water system 10 is provided with the water softener system 18. As shown, hard water 30 may be supplied from the pump 14 to the home water system 10 and either recirculate through the home water system 10 (and exit through the faucets 12) without treatment or be provided to the water softener system 18. After treatment, soft water 32 may be generated from the hard water 30, and the soft water 32 may exit the water softener system 18. The soft water 32 may then be provided through the outlets 24 to one or more home appliances including, but not limited to, the laundry system 20, a bathtub, a toilet, and a kitchen sink.

In some instances, the hard water 30 may flow through the home water system 10 without treatment. While treated water may be preferable for many consumers, including when the consumers are washing clothes, using soap and detergent, and/or rinsing objects, home water systems such as the home water system 10 may include bypass features (e.g., bypass conduits 34) that are designed to allow the hard water to bypass the water softener system 18.

In certain instances, the water softener system 18 may advantageously facilitate the testing of the hard water 30 without the use of complex mechanical components or a plurality of testing probes. In turn, this may lead to reduced monetary and energy costs associated with treatment and, as a result, more efficient distribution of soft water 32 through the home water system 10 and ultimately to the various home appliances connected to the outlets 24.

It is to be understood that while a home water system (i.e., a home water system 10) is shown in FIG. 1A, the water softener system 18 may be used in any residential or commercial setting. For example, the water softener system 18 may be provided as part of the water system of a restaurant, a coffee shop, a beverage and/or ice dispenser, a fitness center, or the like.

FIG. 1B depicts a visual representation of an interior of a typical water softener, such as the water softener system 18 of FIG. 1A. The water softener system 18 may be provided in the form of an inlet conduit 50, an outlet conduit 52, an internal pipe 54, a resin tank 56, and a controller 60. Hard water 30 may flow into the resin tank 56 via the inlet conduit 50 and may be provided to a resin bed 64 in a bottom portion of the resin tank 56 by the internal pipe 54.

In certain instances, the internal pipe 54 may be designed to place the resin bed 64 in fluid communication with the outlet conduit 52. The internal pipe 54 may also separate the hard water 30 flowing downwardly and to the resin bed 64 from the soft water 32 flowing upwardly and exiting the resin bed 64. The soft water 32 may then flow out of the outlet conduit 52 to return to the home water system 10 described in FIG. 1A.

Referring again to FIG. 1B, in some instances, the resin bed 64 may be provided in the form of resin beads 66. The resin beads 66 may be designed to remove divalent and trivalent compounds from the hard water 30. For instance, the resin beads 66 may provide a surface to which the divalent and trivalent ions in the hard water 30 can bond, thereby replacing the divalent and trivalent ions with monovalent ions (e.g., sodium and potassium) and generating a treated water (i.e., the soft water 32).

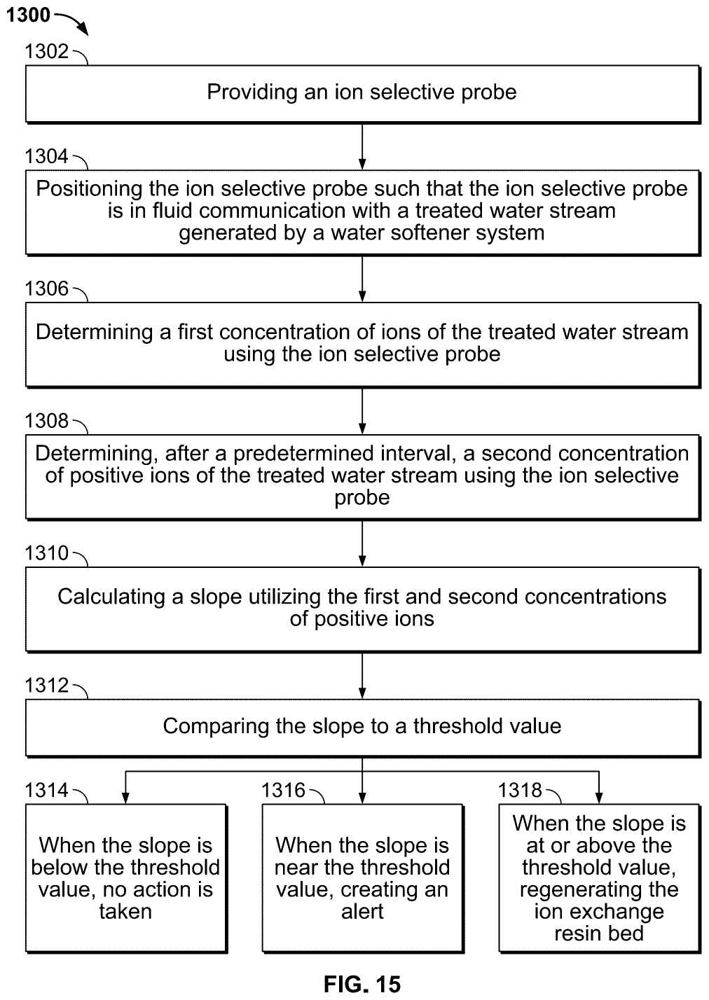

The controller 60 may monitor the status of the resin bed 64 to determine whether a regeneration of the resin bed 64 is needed (see, e.g., a method 1300 further described with reference to FIG. 15). Regeneration of the resin bed 64 may be required when some, substantially all, or all of the resin beads 66 are saturated with divalent and trivalent ions released from the hard water 30. When saturated, the capacity for the resin beads 66 to accept additional divalent and trivalent ions from the hard water 30 is reduced, leading to treatment failure. In response to an alert for regeneration, the controller 60 may direct actuation of one or more valves (not shown) associated with the conduits 50, 52 to prevent the hard water 30 from entering or exiting the water softener system 18 until after the resin bed 64 has been washed with a brine solution. The brine solution may be designed to remove unwanted impurities and multivalent ions from the resin bed 64. In certain cases, the water softener system 18 may be coupled to a drain (such as the drain 22 in FIG. 1A) to expel used brine or excess water after regeneration has occurred.

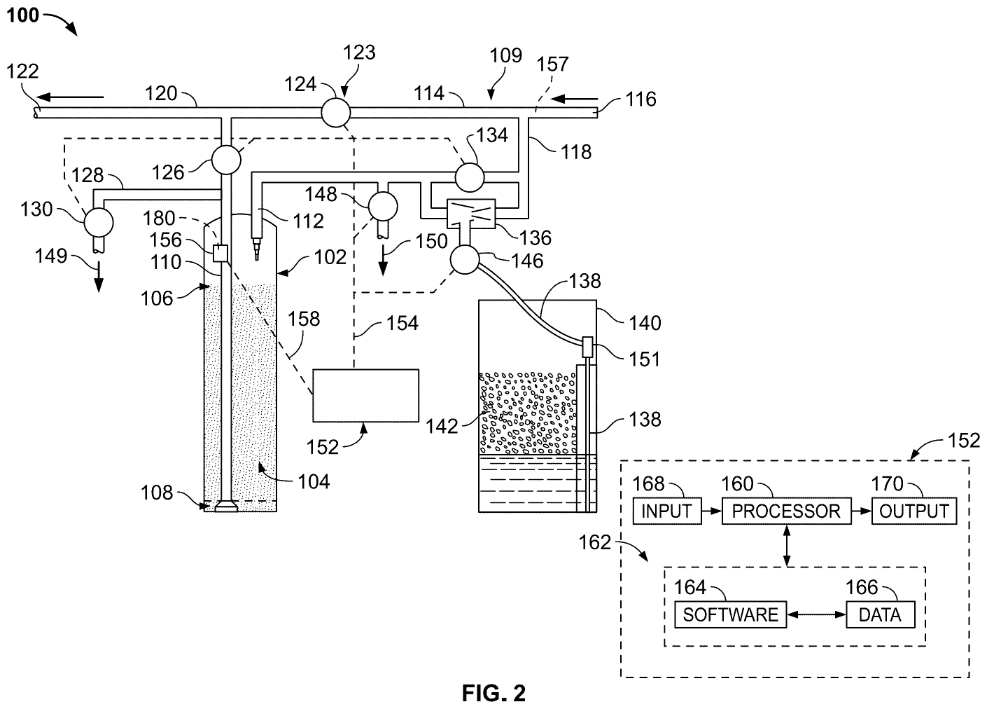

In some instances, the controller 60 may monitor the status of the resin bed 64 using an ion-selective probe 68. The ion-selective probe 68 may be in fluid communication with the outlet conduit 52, the internal pipe 54, and/or any other conduit which carries the soft water 32. The ion-selective probe 68 may be designed to measure a concentration of ions in the hard water 30 or, as depicted in FIG. 1B, the soft water 32. In some instances, more than one ion-selective probe may be utilized in the water softener system 18 such that the concentration of more than one ion type may be measured simultaneously. In other instances, the ion-selective probe 68 may be designed to measure more than one type of ion. Features and functionality of the ion-selective probe 68 are further described with reference to a first ion-selective probe 156 of FIG. 2.

Referring now to FIG. 2, a water softener system 100 is provided. In certain instances, the water softener system 100 may be provided as the water softener system 18 of FIGS. 1A and 1B. Components of the water softener system 100 having similar names and/or element numbers as components of the water softener system 18 may have substantially the same structure and function as the components of the water softener system 18. For example, the water softener system 100 may be in fluid communication with an ion-selective probe designed to monitor the ion concentration of soft water provided from the water softener system 100 such that resin bed breakthrough may be monitored. However, unlike the water softener system 18, the water softener system 100 may include a separate, standalone brine tank that is in fluid communication with a treatment tank 102.

As shown in FIG. 2, the water softener system 100 may be provided in the form of a treatment tank 102 including an ion exchange resin bed 104, one or more conduits 109, one or more valves 123, and a brine tank 140. The treatment tank 102 may be provided in the form of a substantially hollow cylinder, although the treatment tank 102 may also be provided in other shapes (e.g., cube, rectangular prism, cuboid, pyramid, parallelepiped, and trapezoidal prism shapes). The treatment tank 102 may be designed to perform functions substantially similar to those of the water softener system 18 of FIGS. 1A and 1B, in which incoming hard water may be treated upon exposure to resin and exit the treatment tank 102 as treated soft water.

The one or more conduits 109 may be designed to place various components of the water softener system 100 into fluid communication. For example, the one or more conduits 109 may be designed to facilitate the flow of untreated water, treated water, and brine solutions throughout the water softener system 100. The one or more conduits 109 may be provided in the form of substantially hollow cylinders, although the one or more conduits 109 may also be provided in other shapes. The one or more conduits 109 may be constructed of a rust-resistant material, such as stainless steel, PVC, or copper alloys, although the one or more conduits 109 may also be constructed from other materials. In certain instances, the one or more conduits 109 may include conduits 110, 112, 114, 118, 120, 128, 138, as further described below. Alternatively, the one or more conduits 109 may include fewer conduits or additional conduits than described herein.

Referring still to FIG. 2, the one or more valves 123 may be designed to help control fluid flow through the water softener system 100. In some instances, the one or more valves 123 may be manually operated and require a user to alter an open or closed configuration of the one or more valves 123. In other instances, the open or closed configuration of the one or more valves 123 may be controlled by an external controller (e.g., a controller 152) without manual input or manipulation. The one or more valves 123 may also include a common switching mechanism such that all and/or a subset of the one or more valves 123 may be opened and/or closed simultaneously. In other instances, the one or more valves 123 may be controlled individually. In certain cases, the one or more valves 123 may include valves 124, 126, 130, 134, 146, 148. Alternatively, the one or more valves 123 may include fewer valves or more valves than described herein.

The ion exchange resin bed 104 may be located within the treatment tank 102 and may be provided as ion exchange resin particles. The ion exchange resin bed 104 may be designed to remove one or more of the following ions from untreated water provided to the treatment tank 102: calcium ions, magnesium ions, aluminum ions, barium ions, strontium ions, iron ions, zinc ions, and manganese ions. In some instances, the resin particles of the resin bed 104 may be provided as spherical or ovoidal components (i.e., resin beads), although the resin particles may be provided in any regular or irregular three-dimensional shape. In other instances, the ion exchange resin bed 104 may comprise resin beads provided as a polystyrene-type gel resin. The resin particles may further be of any size, volume, and cross-section, which may be selected in accordance with factors such as the size of the treatment tank 102, the anticipated hardness of the incoming water, an anticipated operating temperature and/or pressure of the water softener system 100, cost consideration, and the like. In yet other instances, the ion exchange resin bed 104 may have a porous, skeletal structure.

In some instances, the ion exchange resin particles of the resin bed 104 may be provided in the form of a polymeric structure including multiple binding sites for sodium and/or potassium ions. The binding sites in the resin particles of the ion exchange resin bed 104 may initially contain positive ions, e.g., monovalent sodium and/or potassium ions. As hard water enters the ion exchange resin bed 104, divalent and trivalent ions in the hard water (commonly calcium and/or magnesium ions) may compete with the sodium ions and/or potassium ions for the binding sites. Divalent and trivalent ions in the hard water have higher charge densities than the sodium and/or potassium ions and therefore displace the sodium ions and/or potassium ions bound to the resin particles of the resin bed 104. Thus, as the hard water passes through the ion exchange resin bed 104, the positively charged sodium ions and/or potassium ions may be replaced with calcium ions and/or magnesium ions, thereby removing calcium and magnesium from the hard water, while sodium and/or potassium may be released and dissolved in the treated water.

Referring still to FIG. 2, various components of the water softener system 100, such as the tanks 102, 140, may be placed in fluid communication with a source of untreated water (i.e., hard water) via the one or more conduits 109. Furthermore, various components of the water softener system 100, including the tanks 102, 140, may be placed in fluid communication via the one or more conduits 109. For example, the system inlet 116 may be in fluid communication with a source of untreated water and may provide the untreated water to the treatment tank 102 via the treatment conduit 118 and the tank inlet conduit 112. As will be further described herein, the flow of treated and untreated water through the water softener system 100 may be regulated via the actuation (e.g., the opening and closing) of the one or more valves 123 associated with the various conduits of the water softener system 100.

The water softener system 100 may include the system inlet 116 which is designed to provide hard water to the inlet conduit 114. After entering the inlet conduit 114, the hard water may be delivered to the tank inlet conduit 112 through the tank inlet valve 134 and the treatment conduit 118. Alternatively, when the water softener system 100 operates in the regeneration mode, the hard water entering the system inlet 116 may pass through an injector 136 to draw a brine solution containing a salt compound 142 from the brine tank 140. This may occur when the brine inlet valve 146 is open and when the tank inlet valve 134 is closed.

The tank inlet conduit 112 may extend into the treatment tank 102 and have a discharge opening positioned above a top portion 106 of the ion exchange resin bed 104. The tank outlet conduit 110 may extend through the ion exchange resin bed 104 and to a point adjacent to a bottom portion 108 of the treatment tank 102. The tank outlet conduit 110 may transfer the treated, softened water out of the treatment tank 102. The softened water may then flow through the output conduit 120 to the outlet 122.

The first output valve 124 may couple the inlet conduit 114 and the output conduit 120. The tank inlet valve 134 may couple the treatment conduit 118 and the tank inlet conduit 112. The first drain conduit 128 may extend from the tank outlet conduit 110 and may be in fluid communication with a first drain 132. The first drain valve 130 may be designed to selectively provide fluid to the first drain 132 (e.g., the first drain valve 130 may be opened when a waste brine solution is disposed of). The treatment conduit 118 may be in fluid communication with a second drain 150. The second drain valve 148 may be designed to selectively provide fluid to the second drain 150. For example, the tank inlet conduit 112 may be placed in fluid communication with the second drain 150 when the second drain valve 148 is open.

Referring still to FIG. 2, the brine tank 140 may be designed to provide or generate a brine solution which is used to regenerate the ion exchange resin bed 104. The brine tank 140 may be filled with the salt compound 142. In some instances, the salt compound 142 may be provided as sodium chloride, potassium chloride, potassium permanganate, or any mixture thereof. When regeneration of the resin bed 104 is required or initiated, the brine inlet valve 146 may be opened and the tank inlet valve 134 may be closed to facilitate delivery of the brine through the brine conduit 138 and to the tank inlet conduit 112.

The water softener system 100 may be configured to operate in one or more modes. For example, the water softener system 100 may operate in at least one of a service mode, a standby mode, and a regeneration mode. In the service mode, untreated water may be supplied to the treatment tank 102 and the water softener system 100 may provide treated water to the end user via the output conduit 120. In the regeneration mode, the water softener system 100 may regenerate the ion exchange resin bed 104 by rinsing the ion exchange resin bed 104 with a brine solution which includes the salt compound 142. The brine solution may be supplied to the treatment tank 102 from the brine tank 140. In the standby mode, the brine tank 140 and/or the treatment tank 102 may be fluidly isolated from the output conduit 120 such that untreated water may be provided to the outlet 122. For example, the standby mode may be initiated when the treated water supplied by the water softener system 100 is not needed. Each of the modes described herein may be manually selected by the end user and/or automatically initiated by the controller 152.

Referring again to FIG. 2, in the service mode, the drain valves 130, 148, the first output valve 124, and the brine inlet valve 146 may each be in a closed configuration. In the service mode, the second output valve 126 and the tank inlet valve 134 may be open such that hard water may flow from the inlet conduit 114, through the tank inlet conduit 112, and to the ion exchange resin bed 104. As water flows from the top portion 106 of the ion exchange resin bed 104 and towards the bottom portion 108 of the treatment tank 102, divalent and trivalent ions may be removed from the water, thereby generating treated water (i.e., soft water). The treated water may be withdrawn from the bottom portion 108 of the treatment tank 102 by flowing upwardly through the tank outlet conduit 110 and into the output conduit 120.

The treated water may comprise water in which minerals, impurities, and particles (e.g., calcium and magnesium ions) have been removed by the ion exchange resin bed 104. In some instances, the treated water may be imparted with a concentration of divalent and trivalent ions of about 0 mg/L (120 ppm) to about 120 mg/L (120 ppm). For example, the treated water may be imparted with a concentration of divalent and trivalent ions of no more than about 10 mg/L (10 ppm), or no more than about 20 mg/L (20 ppm), or no more than about 30 mg/L (30 ppm), or no more than about 40 mg/L (40 ppm), or no more than about 50 mg/L (50 ppm), or no more than about 60 mg/L (60 ppm), or no more than about 70 mg/L (70 ppm), or no more than about 80 mg/L (80 ppm), or no more than about 90 mg/L (90 ppm), or no more than about 100 mg/L (100 ppm), or no more than about 110 mg/L (110 ppm), or no more than about 120 mg/L (120 ppm). Preferably, the treated water is imparted with a concentration of no more than 75 mg/L (75 ppm). In other instances, the treated water may comprise water imparted with a concentration of divalent and trivalent ions of no more than 10 mg/L (10 ppm), or no more than 20 mg/L (20 ppm), or no more than 30 mg/L (30 ppm), or no more than 40 mg/L (40 ppm), or no more than 50 mg/L (50 ppm), or no more than 60 mg/L (60 ppm), or no more than 70 mg/L (70 ppm), or no more than 80 mg/L (80 ppm), or no more than 90 mg/L (90 ppm), or no more than 100 mg/L (100 ppm), or no more than 110 mg/L (110 ppm), or no more than 120 mg/L (120 ppm). In certain instances, the treated water may be imparted with a concentration of divalent and trivalent ions that is somewhat greater than the values recited herein. In some instances, the treated water may be imparted with a concentration of divalent and trivalent ions that falls within a range bounded by any minimum value and any maximum value as described above.

In some instances, the treated water may comprise water imparted with a concentration of divalent and trivalent ions of no more than about 7 grains. For example, the treated water may comprise water imparted with a concentration of divalent and trivalent ions of no more than about 7 grains, or no more than about 6.5 grains, or no more than about 6 grains, or no more than about 5.5 grains, or no more than about 5 grains, or no more than about 4.5 grains, or no more than about 4 grains, or no more than about 3.5 grains, or no more than about 3 grains, or no more than about 2.5 grains, or no more than about 2 grains, or no more than about 1.5 grains, or no more than about 1 grain, or no more than about 0.5 grains. Preferably, the treated water may be imparted with a concentration of no more than about 1 grain. In other instances, the treated water may comprise water imparted with a concentration of no more than 7 grains, or no more than 6.5 grains, or no more than 6 grains, or no more than 5.5 grains, or no more than 5 grains, or no more than 4.5 grains, or no more than 4 grains, or no more than 3.5 grains, or no more than 3 grains, or no more than 2.5 grains, or no more than 2 grains, or no more than 1.5 grains, or no more than 1 grain, or no more than 0.5 grains. In certain instances, the treated water may comprise water imparted with a grain value of divalent and trivalent ions that is somewhat less or greater than the values recited herein. In some instances, the treated water may be imparted with a grain value of divalent and trivalent ions that falls within a range bounded by any minimum value and any maximum value as described above.

In the regeneration mode, untreated water entering the inlet conduit 114 may pass through the injector 136 and draw the salt compound 142 from the brine tank 140. When this occurs, the brine inlet valve 146 may be open and the tank inlet valve 134 may be closed. The withdrawn salt compound 142 may be delivered through the brine conduit 138 to the tank inlet conduit 112 of the treatment tank 102. The tank inlet conduit 112 may also be placed in fluid communication with the second drain 150 via the second drain valve 148. When the brine tank 140 is exhausted, an air check valve 151 may close to prevent air from being injected into the water softener system 100, and water may continue to flow through the injector 136.

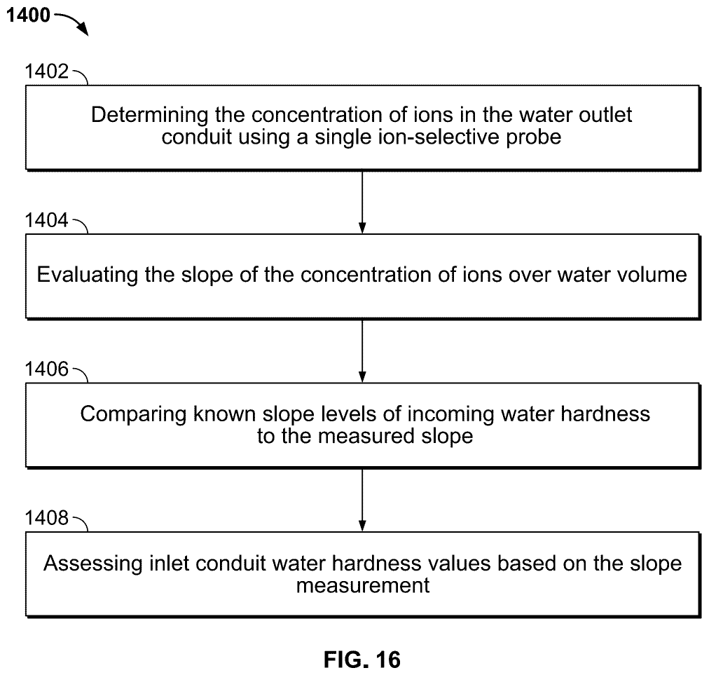

The regeneration mode may be initiated when the ion exchange resin bed 104 is substantially or completely exhausted. When the ion exchange resin bed 104 is substantially exhausted, the ion exchange resin bed 104 may no longer be capable of treating or softening the water (i.e., the ion exchange resin bed 104 may be functioning at a lower capacity). This condition may be referred to as resin breakthrough. Resin breakthrough occurs when the treatment capacity of the resin bed has been exceeded, specifically when a sufficient percentage of the sites in the resin become occupied by the divalent and trivalent ions such that the resin bed is no longer effective for treating hard water. In some instances, the resin breakthrough may occur when the percentage of sites in the resin bed occupied by divalent and/or trivalent ions is at least about 50%, or at least about 60%, or at least about 70%, or at least about 80%, or at least about 90%, or about 100% of the sites. In some instances, resin breakthrough may be determined in accordance with the components described herein and the methods 1300, 1400 as further described with reference to FIGS. 15 and 16.

Referring again to FIG. 2, when resin breakthrough occurs in the water softener system 100, it may be necessary to regenerate the ion exchange resin bed 104 by flushing or soaking the ion exchange resin bed 104 with a brine solution that includes the salt compound 142. For example, the ion exchange resin bed 104 may be soaked in a concentrated solution of sodium chloride, thereby dislodging the calcium and magnesium ions bound to the ion exchange resin bed 104. In some instances, the concentrated solution is a solution imparted with a volume/volume percent of about 3.5% to about 26% of sodium chloride or potassium chloride. Additionally, during resin bed 104 regeneration, the sodium or potassium in the salt compound 142 may affix to the resin particles. After the regeneration, waste generated by the resin regeneration process, including excess brine solution, leftover salt compound 142, and/or the dislodged divalent and trivalent ions (e.g., calcium ions) may be removed from the water softener system 100 by directing the waste to the first drain 132 via the first drain conduit 128. In such instances the first drain valve 130 may be arranged in the open configuration.

In some instances, the regeneration mode may comprise a backwash step, a brining step, and/or a rinsing step. In the backwash step, the controller 152 may close the tank inlet valve 134 and the brine inlet valve 146 and may open the first output valve 124 and the second drain valve 148. Hard water from the inlet conduit 114 may flow through the tank outlet conduit 110 and upwardly through the ion exchange resin bed 104 before exiting the treatment tank 102 via the tank inlet conduit 112. Once the hard water exits the tank inlet conduit 112, the hard water may be provided to the second drain valve 148 and may exit the water softener system 100 via the second drain 150. During regeneration, water may continue to be supplied to the output conduit 120 (and thus to the end user) even though the water is not treated in the treatment tank 102.

The backwash step may be followed by the brining step and the rinsing step. In the brining step, the second output valve 126 and the second drain valve 148 may be closed while the brine inlet valve 146 and the first drain valve 130 may be opened. In this state, hard water may flow through the injector 136 and brine solution may be withdrawn from the brine tank 140 via the brine conduit 138. The withdrawn brine solution may be discharged into the treatment tank 102 through the tank inlet conduit 112. The brine solution may then pass through the ion exchange resin bed 104. As the brine solution passes through the ion exchange resin bed 104, the salt compound 142 may replace the divalent and trivalent ions bound to the resin bed with monovalent ions, recharging the ion exchange resin bed 104. When the contents of the brine tank 140 have been exhausted, the air check valve 151 may close to prevent air from being injected into the system. After being provided to and/or soaking the resin bed 104, the brine solution may be drained from the treatment tank 102 via the tank outlet conduit 110. The brine solution may then be provided to the first drain 132, as the first drain valve 130 may be in the open configuration.

In the rinsing step, water may continue to flow through the brine conduit 138. The rinsing water may be free or substantially free of the brine solution. The rinsing water may rinse the treatment tank 102 and the ion exchange resin bed 104 to remove any residual salt compound 142, thereby completing the regeneration of the ion exchange resin bed 104. Untreated water may be supplied to the output conduit 120 through the first output valve 124 during the regeneration mode.

In some instances of the backwash step, the ion exchange resin bed 104 may be provided with about 100 mL to about 500 mL of the brine solution, although the amount of the brine solution containing the salt compound 142 provided to the ion exchange resin bed 104 may be somewhat less than or even greater than these values. For example, the ion exchange resin bed 104 may be dosed with at least about 100 mL, or at least about 150 mL, or at least about 200 mL, or at least about 225 mL, or at least about 250 mL, or at least about 275 mL, or at least about 300 mL, or at least about 325 mL, or at least about 350 mL, or at least about 375 mL, or at least about 400 mL, or at least about 450 mL, or at least about 500 mL of the brine solution containing the salt compound 142. As an additional example, the ion exchange resin bed 104 may be dosed with at least 100 mL, or at least 150 mL, or at least 200 mL, or at least 225 mL, or at least 250 mL, or at least 275 mL, or at least 300 mL, or at least 325 mL, or at least 350 mL, or at least 375 mL, or at least 400 mL, or at least 450 mL, or at least 500 mL of the brine solution containing the salt compound 142. In some instances, the dose of the brine solution containing the salt compound 142 provided to the ion exchange resin bed 104 may fall within a range bounded by any minimum value and any maximum value as described above.

While the regeneration mode has been described herein as including the backwash step, the brining step, and the rinsing step, the regeneration mode may include additional or fewer steps than those described herein.

After the regeneration of the ion exchange resin bed 104, the brine tank 140 may be refilled. This may be accomplished by opening the tank inlet valve 134 and the second output valve 126. Hard water may enter the brine tank 140 through the brine inlet valve 146 that is in the open configuration. When the hard water enters the brine tank 140, the hard water may dissolve solid salts deposited in the brine tank 140, thereby generating fresh brine solution containing the salt compound 142.

The water softener system 100 may be returned to the service mode after the regeneration mode is complete by closing the first output valve 124, the first drain valve 130, and the brine inlet valve 146.

The water softener system 100 may include a first ion-selective probe 156. The first ion-selective probe 156 may be coupled to and/or in fluid communication with the tank outlet conduit 110, although the first ion-selective probe 156 may also be provided elsewhere in the water softener system 100. The first ion-selective probe 156 may be designed to measure or detect the concentration of monovalent, divalent, and/or trivalent ions in a water sample. For example, the first ion-selective probe 156 may measure the concentration of at least one of the following ions in the untreated water or the treated water: calcium, magnesium, barium, aluminum, strontium, iron, zinc, and manganese ions. As an additional example, the first ion-selective probe 156 may measure the concentration of calcium ions in the treated water or the untreated water. As yet another example, the first ion-selective probe 156 may measure the concentration of magnesium ions present in the untreated water or the treated water. In certain cases, the first ion-selective probe 156 may be the only probe utilized in the water softener system 100 that is designed to measure the concentration of monovalent, divalent, and/or trivalent ions.

In some instances, more than one ion-selective probe may be provided in the water softener system 100. For example, a second ion-selective probe 157 may be in fluid communication with the inlet conduit 114 (as shown) and/or another of the one or more conduits 109. Like the first ion-selective probe 156, the second ion-selective probe 157 may be designed to measure the concentration of various ions in the untreated water or the treated water, such as sodium or potassium ions.

The first ion-selective probe 156 may be used to determine when the resin bed 104 is experiencing resin breakthrough. Alternatively, or additionally, the first ion-selective probe 156 may be used to determine a hardness of water provided to the system inlet 116 (also referred to as “incoming water hardness”). In some instances, the first ion-selective probe 156 may determine a first concentration of ions of the treated water stream and, after a predetermined time interval, a second concentration of positive ions of the treated water stream. In some instances, to determine the likelihood or risk of resin breakthrough, the concentration values measured by the first ion-selective probe 156 may be used to determine a slope generated from the measurements of positive ions in the treated water stream. In addition, the controller 152 may determine whether the slope is above, below, or equal to a threshold value to determine a subsequent action of the water softener system 100. In some instances, when the slope is below the threshold value, no action is taken by the water softener system. In certain instances, when the slope is near or approaches the threshold value (e.g., within about 10% of the threshold value), an alert is created. In some cases, when the slope is at or above the threshold value, the resin bed 104 of the water softener system 100 is regenerated.

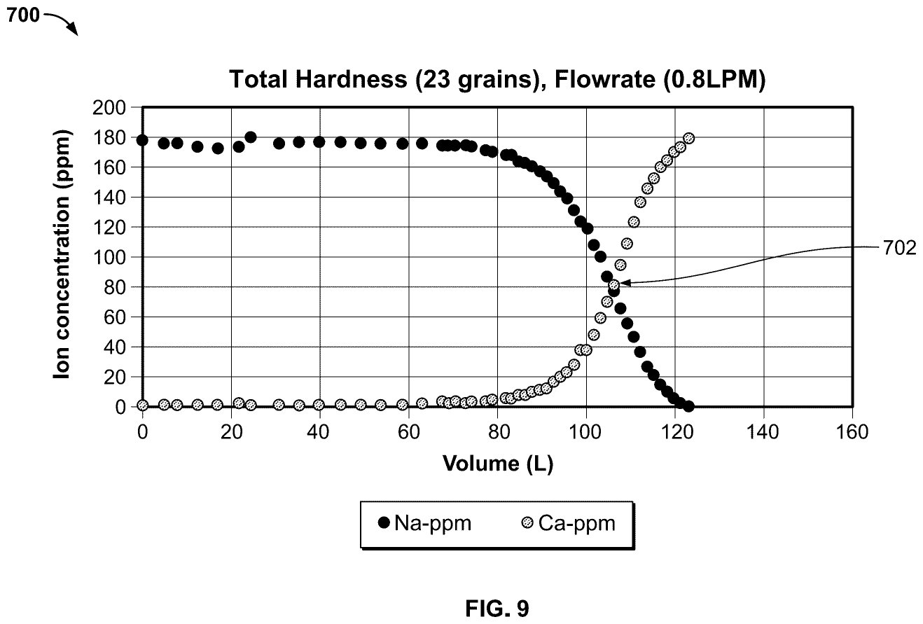

In some instances, the first ion-selective probe 156 may determine the concentration of various ions (including sodium and calcium ions) over water volume, as shown in FIGS. 9-14. In some instances, the first ion-selective probe 156 may determine the concentration of potassium ions over water volume. The water volume may be determined by a sensor (e.g., a flow sensor) designed to monitor the amount of water provided to the water softener system 100 and/or the treatment tank 102. In some instances, the first ion-selective probe 156 may include a flow sensor. In other instances, the first ion-selective probe 156 may be associated with a flow sensor. As will be further explained herein, the information collected by the first ion-selective probe 156 and the flow sensor may be provided as an input 168 to the controller 152.

In certain instances, more than one ion-selective probe may be used to determine resin bed 104 breakthrough and/or the incoming water hardness at the system inlet 116. For example, two or more ion-selective probes (e.g., the first and second ion-selective probes 156, 157) may be utilized in the water softener system 100. The two or more ion-selective probes may determine a first concentration of monovalent ions of the treated water stream and a second concentration of divalent and/or trivalent ions of the treated water stream. For example, the two or more ion-selective probes may determine the concentrations of sodium and calcium of the treated water stream. In some instances, to determine the likelihood or risk of resin breakthrough, the concentration values measured by the two or more ion-selective probes may be used to determine an ion differential based on the measured concentration values. The ion differential may be compared to a threshold value to determine a subsequent action of the water softener system 100. For example, when the ion differential is above the threshold value, no action may be taken by the water softener system 100. As an additional example, when the ion differential is near the threshold value (e.g., within about 10% of the threshold value), an alert may be created. As yet another example, when the ion differential is at or below the threshold value, the water softener system may be regenerated. In certain cases, the data or information collected by the two or more ion-selective probes may be provided as the input 168 to the controller 152.

In some instances, the ion-selective probes (e.g., the first ion-selective probe 156 and the second ion-selective probe 157) provided in the water softener system 100 may be provided as any ion-selective probe or electrode designed to measure positive ion concentrations in an aqueous solution. In other instances, the ion-selective probes may be designed to measure an ion concentration in a range of about 1 mg/L (1 ppm) to about 40,000 mg/L (40,000 ppm). In various instances, the ion-selective probes may be imparted with a measurement precision of about +10%. In various instances, the ion-selective probes may be designed to carry out measurements when the pH of the untreated or treated water is in a range of about 2 to about 8. In some instances, the ion-selective probes may comprise an electrode slope of +26 mV/decade at 25° C. In various instances, the ion-selective probes may be imparted with an electrode resistance of at least about 1 MΩ, or at least about 10 MΩ, or at least about 100 MΩ.

In some instances, the first ion-selective probe 156 (and/or any of the ion-selective probes provided in the water softener system 100) may continuously, intermittently, and/or at predetermined times measure the concentrations of various ions in the water passing through the tank outlet conduit 110. Thus, the first ion-selective probe 156, in conjunction with the controller 152, may be used to determine when resin breakthrough of the ion exchange resin bed 104 has occurred or is imminent. For example, the controller 152 may determine the slope of divalent or trivalent ion concentrations at intervals of the volume of water processed by the water softener system 100 to identify when resin breakthrough of the ion exchange resin bed 104 has occurred. Thus, the controller may use the determined slope to determine whether to regenerate the ion exchange resin bed 104. Alternatively, the first ion-selective probe 156, in conjunction with the controller 152, may be used to determine when resin bed breakthrough has occurred by determining an ion differential based on the monovalent and divalent/trivalent ion concentrations in order to identify whether to regenerate the ion exchange resin bed 104.

Referring again to FIG. 2, the water softener system 100 and/or various components of the water softener system 100 (including the one or more valves 123 and the first ion-selective probe 156) may be in communication with the controller 152. The controller 152 may be a local controller associated with the water softener system 100, or the controller 152 may be a central controller designed to control one or more components of a home water system (e.g., the home water system 10 of FIG. 1A).

The controller 152 can implement a number of different methods and processes to effectuate different operational conditions and functions of the water softener system 100 (e.g., a regeneration mode, a standby mode, a service mode). For example, the controller 152 may direct actuation of the one or more valves 123 into the open configuration and the closed configuration. As an additional example, the controller 152 may automate testing conducted by the first ion-selective probe 156. As yet another example, the controller 152 may effectuate any of the operational modes or processes described with reference to FIG. 2.

The controller 152 may operate in conjunction or independently from one or more local controllers. For conciseness, the methods of FIGS. 15 and 16 reference a singular central controller (i.e., the controller 152), although the one or more functions described in the methods may also be performed by the controller 152 and/or one or more local controllers associated with the devices described herein. Alternatively, one or more local controllers associated with the water softener system 100 may work in conjunction with, or independent from, the controller 152 to effectuate the operational modes and other methods described with reference to FIGS. 1A-16.

The controller 152 may further utilize a Local Area Network (LAN), a Wide Local Area Network (WLAN), Ultra Mobile Broadband (UMB), Institute of Electrical and Electronics Engineers (IEEE) 802.11 (Wi-Fi), IEEE 802.16 (WiMAX), IEEE 802.20, Flash-OFDM, a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein, to transmit and receive information. Furthermore, the controller 152 can receive data from one or more of the components of the water softener system 100, analyze the data as discussed herein, and determine actions associated with one or more of the methods described above. Thus, the controller 152 may create one or more communication links 154 that operatively connects the components of the water softener system 100. For clarity, only selected communication links of the one or more communication links 154 are shown in FIG. 2

In some instances, a lookup table of predetermined values, thresholds, ranges, and other information may be stored by the controller 152, and the controller 152 may determine an appropriate action based on one or more of the variables discussed herein. Furthermore, the controller 152 may be in communication with a network and may be capable of downloading lookup tables. The controller 152 may select threshold values from the lookup tables based on a number of factors including environmental pressure, flow rate, temperature, pH, turbidity, expected water hardness, measured water hardness, electrode sensitivity, and/or other parameters.

Referring again to FIG. 2, the controller 152 may include a processor 160 and a memory 162. The memory 162 may include software 164 and data 166 and is designed for storage and retrieval of processed information to be processed by the processor 160. The processor 160 can be a programmable processor communicatively coupled to the memory 162. In some instances, the processor 160 can include program instructions that are stored on a cloud server non-transitory computer readable medium and that are executable by the processor 160 to perform one or more of the methods described herein. The processor may include the input 168 that is designed to receive process signals (e.g., signals from a measurement device, such as the first ion-selective probe 156).

The controller 152 may operate autonomously or semi-autonomously, and/or may read executable software instructions from the memory 162 or a computer-readable medium (e.g., a hard drive, a CD-ROM, flash memory), and/or may receive instructions via the input 168 from a user, or another source logically connected to a computer or device, such as another networked computer or server. For example, the server may be used to control opening and/or closing of valves during a regeneration process, either on-site or remotely. The processor 160 may process the process signals and input to generate an output 170. The output 170 may take the form of a process control action. Examples of process control actions may include initiating any of the modes of the water softener system 100 (e.g., the service, regeneration, and/or standby modes) or sending signals to open or close any of the one or more valves 123 either partially or completely. Other example process control actions may include routing waste product to the first drain 132 and the second drain 150 such that any excess waste created by regenerating the resin bed 104 can be removed from the water softener system 100. Yet other example process control actions may include providing alerts to a user that the resin bed 104 needs regeneration or is close to needing regeneration. Such alerts may be provided to the user via a mobile-phone text communication, a notification to a mobile application, an email message, and/or other similar electronic means.

The memory 162 may be designed to store system information received from the one or more system components and/or user inputs. In some instances, the memory 162 may be integrated with one or more of the water softener system 100 components discussed herein. In other instances, the memory 162 may be implemented as a standalone memory unit. In some instances, the memory 162 may retain historical information regarding a consumer's usage of the water softener system 100 such that changes in the ion concentration of the water inflow provided to the water softener system 100 can be predicted by the controller 152. For example, the memory 162 may retain information related to the volume of hard water provided from the source to the system inlet 116, the hardness value of the water provided to the system inlet 116, and/or the concentration of various ions in the water flowing through the tank outlet conduit 110, and other similar information. In some such instances, the controller 152 may use this information as input to adapt or change the operational mode of the water softener system 100 based on information from the first ion-selective probe 156, thereby providing treated water to the outlet 122 (e.g., the service mode) or regenerating the ion exchange resin bed 104 using the brine tank 140 (e.g., the regeneration mode). After resin breakthrough of the resin bed 104 is determined by the controller 152, the water softener system 100 of FIG. 2 may initiate the regeneration mode to regenerate the ion exchange resin bed 104.

The controller 152 of the water softener system 100 may be designed to predict both resin breakthrough of the resin bed 104 and incoming water hardness by utilizing measurements obtained from the first ion-selective probe 156. In some instances, the controller 152 may predict resin breakthrough and/or a risk of breakthrough by determining a slope of ion concentration (e.g., measured in ppm) versus the volume of water that has passed through the water softener system 100 or the treatment tank 102 (e.g., measured in liters). In various instances, the controller 152 may determine the slope using the equation y=mx+b, where m is the determined slope, x is the volume of water, y is the divalent or trivalent ion concentration in the sampled water, and b is the y-intercept. In some instances, the controller 152 may predict breakthrough of the resin bed 104 or the risk of breakthrough by determining a slope of divalent or trivalent ion concentration (e.g., measured in ppm) versus the volume of water that has passed through the treatment tank 102 (e.g., measured in liters). In various instances, the first ion-selective probe 156 may measure the divalent or trivalent ions in the sampled water at time intervals of about every millisecond, about every second, about every minute, about every 10 minutes, about every 30 minutes, about every hour, about every 24 hours, about every 48 hours, about every 72 hours, about every week, or about every month. The first ion-selective probe 156 may also measure ions in the sampled water at other intervals not specified herein. In certain instances, the measured divalent or trivalent ion may be calcium ions and/or magnesium ions.

In other instances, the first ion-selective probe 156 may measure the divalent or trivalent ions at intervals of about every 1 mL, or about every 50 mL, or about every 100 mL, or about every 250 mL, or about every 500 mL, or about every 1 L, or about every 5 L, or about every 10 L, or about every 20 L, or about every 50 L of water processed by the treatment tank 102. A flow sensor 180 may be provided to measure a volume of water flowing through the water softener system 100. For example, the flow sensor 180 may be positioned within or coupled to the first ion-selective probe 156. Alternatively, the flow sensor 180 may be in fluid communication with any of the components of the water softener system 100 (e.g., any of the one or more conduits 109), including the tank inlet conduit 112 and the tank outlet conduit 110. In some such instances, the flow sensor 180 may be electrically coupled to the first ion-selective probe 156 and the controller 152 such that incoming hard water may be tested on a regular basis of water volume.

Referring again to FIG. 2, the controller 152 may collect data 166 from the first ion-selective probe 156 and store the data 166 for analysis. The data 166 may comprise information related to the hardness of the treated water and the volume of water produced by the treatment tank 102. The volume of water produced by the treatment tank 102 may be determined based on parameters such as a time since the last regeneration, a predetermined time period, and/or other similar criteria. The controller 152 may determine the rate of change of the water hardness value versus the volume of water flowing through the treatment tank 102 (i.e., the controller 152 may determine a slope, as described herein). Alternatively, the controller 152 may determine an ion differential based on the concentrations of at least two types of positively charged ions, wherein at least one type is a monovalent ion such as sodium or potassium, and the other type is a divalent or trivalent ion, such as calcium or magnesium.

I In some instances, the controller 152 may determine a breakthrough slope. Once the breakthrough slope has been determined by the controller 152, the determined breakthrough slope may be used in conjunction with at least one threshold value to determine a subsequent action. For example, when the determined breakthrough slope is at or below a first threshold value, the controller 152 may determine that the resin bed 104 is in normal operating condition and does not need regeneration. Thus, the water softener system 100 may continue operating in the service mode. As an additional example, when the determined breakthrough slope is at or above a second threshold value (but below a third threshold value), the controller 152 may determine that a breakthrough of the resin bed 104 is imminent. In such cases, the controller 152 may provide an alert to the user indicating that the resin bed 104 needs regeneration within a defined time period to help ensure that the water softener system 100 remains functional. As a further example, when the determined breakthrough slope is at or above a third threshold value, the controller 152 may determine that resin breakthrough of the resin bed 104 has occurred. When the controller 152 determines that resin breakthrough has occurred, the controller 152 may provide an alert to the user that the water softener system 100 is no longer functioning properly and/or the controller 152 may direct the water softener system 100 to enter the regeneration mode.

In some instances, once an ion differential value has been determined, the value of the determined ion differential may be used in conjunction with at least one threshold value by the controller 152 to determine a subsequent action. For example, when the determined ion differential is at or above a first threshold value, the controller 152 may determine that the resin bed 104 is in normal operating condition and does not need regeneration. Thus, the water softener system 100 may continue operating in the service mode. As an additional example, when the determined ion differential is at or below a second threshold value (but above a third threshold value), the controller 152 may determine that a breakthrough of the resin bed 104 is imminent. In such cases, the controller 152 may provide an alert to the user indicating that the resin bed 104 needs regeneration within a defined period to help ensure that the water softener system 100 remains functional. As a further example, when the determined ion differential is at or below a third threshold value, the controller 152 may determine that resin breakthrough has occurred. When the controller 152 has determined that resin breakthrough has occurred, the controller 152 may provide an alert to the user that the water softener system 100 is no longer functioning properly and/or the controller 152 may direct the water softener system 100 to enter the regeneration mode.

In some instances, the second threshold value may be defined in relation to the third threshold value. For example, the second threshold value may be imparted with a value of no more than about 85% of the third threshold value, although the second threshold value may be somewhat less or greater than these values. For example, the second threshold value may be imparted with a value of at least about 85%, or at least about 90%, or at least about 95%, or at least about 97%, or at least about 99% of the third threshold value. As another example, the second threshold value may be imparted with a value of at least 85%, or at least 90%, or at least 95%, or at least 97%, or at least 99% of the third threshold value. In some instances, the second threshold value may be provided as a value or a range bounded by any minimum value and any maximum value as described above.

In some instances, the first, second, and third threshold values may be determined in real time based on measurements obtained by the first ion-selective probe 156. For example, the controller 152 may determine the rate of change or slope of the positively charged ion concentration versus the volume of water flowing through the water softener system 100 at predetermined intervals. If a first determined slope is less than or equal to a second determined slope, and a third determined slope is greater than the first and second determined slopes, the controller 152 may determine that resin breakthrough has occurred. As an additional example, if the first determined slope is less than the second determined slope by at least a first predetermined amount, and if the third determined slope is greater than both the first and second determined slopes by more than a second predetermined amount, then the controller 152 may determine that resin breakthrough has occurred. In such instances, the first and second predetermined amounts may be at least about 1 ppm per volume of water, or at least about 5 ppm per volume of water, or at least about 10 ppm per volume of water, or at least about 20 ppm per volume of water, or at least about 30 ppm per volume of water, although the first and second predetermined amounts may be even greater than these values. In some such instances, the first and second threshold values may be the same, or the first and second threshold values may be different. In certain cases, the first and second threshold values may fall within a range bounded by any minimum value and any maximum value as described above.

Referring again to FIG. 2, the first ion-selective probe 156 may also be used to determine the amount of calcium and/or magnesium in the source water entering the system inlet 116 of the water softener system 100. In various instances, the concentration of calcium and magnesium ions in the water provided to the system inlet 116 can be determined using look-up tables based on testing for different incoming hardness waters in the range of about 1 grain to about 40 grains. In some instances, the treated water generated by the treatment tank 102 may be imparted with a predetermined, defined water hardness value, which in turn is measured by the first ion-selective probe 156. The controller 152 may then associate the value measured by the first ion-selective probe 156 with a comparative value in the look-up table to determine the hardness of water entering the inlet conduit 114. In various instances, the hardness of water entering the inlet conduit 114 may be determined as hardness=slope*x, where x is the volume of water treated by the treatment tank 102 or flowing through the water softener system 100.

The determined slope values may at least partially depend on a volume of the ion exchange resin bed 104 utilized in the water softener system 100 and on the hardness of the incoming water. For example, incoming water imparted with a hardness value of 15 grains may have a lower slope value than incoming water imparted with a higher hardness value (e.g., 20 grains, 25 grains).

In many instances, the first ion-selective probe 156 may detect at least one ion including calcium, magnesium, barium, aluminum, strontium, iron, zinc, and manganese ions. In other instances, the first ion-selective probe 156 may determine ion concentrations in a sample of water, the ions selected from the group consisting of calcium ions, magnesium ions, barium ions, aluminum ions, strontium ions, iron ions, zinc ions, and manganese ions to predict and/or determine the occurrence of resin breakthrough of the resin bed 104 and/or incoming water hardness.

In some instances, the first ion-selective probe 156, in conjunction with the controller 152, may be used to predict and/or determine the occurrence of resin breakthrough of the resin bed 104 and/or the hardness of water provided to a water softening system (such as a point-of-entry (POE) or point-of-use (POU) water softening system), a water purification system, a water filtration system, a reverse osmosis system, and/or another type of water conditioning system. Furthermore, the first ion-selective probe 156 may help determine and/or predict the occurrence of breakthrough of the resin bed 104 and/or incoming water hardness in residential, industrial, or commercial applications.

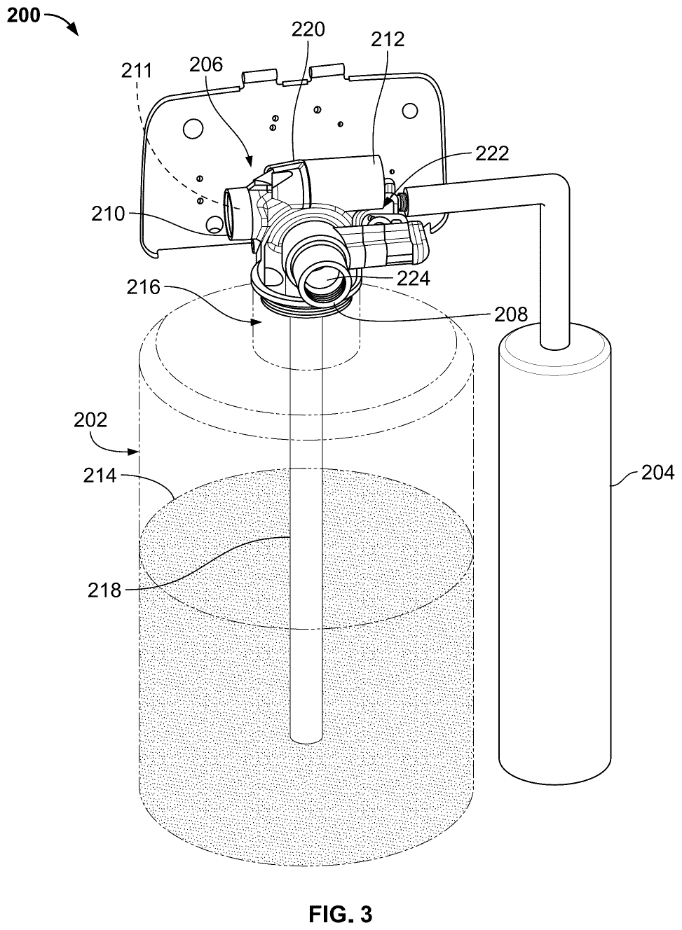

Referring now to FIG. 3, a water softener system 200 is provided. In certain instances, the water softener system 200 may be provided as the water softener system 18 of FIG. 1. Components of the water softener system 200 with similar names and/or element numbers as the water softener systems 18, 100 may have substantially the same structure and function as the components of the water softener systems 18, 100 described with reference to FIGS. 1A and 2. For example, the water softener system 200 may be provided in the form of a treatment tank 202, a brine tank 204, a control valve 206, an inlet 208, an outlet 210, an ion-selective probe 211, a drain outlet 212, an ion exchange resin bed 214, a treatment tank opening 216, a distributor pipe 218, a valve body 220, an injector assembly 222, and a central bore 224. The inlet 208 may be in fluid communication with the treatment tank 202 and may be designed to provide hard water to the treatment tank 202. The treatment tank 202 may be in fluid communication with the outlet 210, which is designed to provide treated water to an end user from the water softener system 200. Treated water may flow out of the treatment tank 202 through the distributor pipe 218 extending through the center of the ion exchange resin bed 214 and to the outlet 210 such that the treated water may be distributed to its intended output location.

In some instances, the water softener system 200 and/or the various components of water softener system 200 (including the control valve 206) may optionally be in communication with a controller (not shown) that is substantially similar in structure and function to the controller 152 or the one or more local controllers described with reference to FIG. 2.

The treatment tank 202 may retain an ion exchange resin bed 214. The brine tank 204 may contain particles of sodium chloride, potassium permanganate, potassium chloride, and/or another suitable regeneration media which can be dissolved by water to form a brine solution or a regenerant solution. In some instances, as shown, the water softener system 200 may include a single ion-selective probe (e.g., the ion-selective probe 211) positioned in, proximate to, or adjacent to the outlet 210. In other instances, the ion-selective probe 211 may be in fluid communication with the outlet 210. In yet other instances, more than one in-selective electrode may be provided with the water softener system 200.

In service mode, untreated hard water may enter the treatment tank 202 through the treatment tank opening 216 provided in a top portion of the ion exchange resin bed 214. The hard water in the treatment tank 202 may be forced to flow through the ion exchange resin bed 214 and out of the treatment tank through the distributor pipe 218. The capacity of the ion exchange resin bed 214 to exchange ions with the minerals and impurities in the incoming hard water is finite and depends on the treatment capacity of ion exchange resin bed 214. To regenerate ion exchange resin bed 214 after the ion exchange resin bed 214 is depleted (i.e. once resin breakthrough has occurred), the ion exchange resin bed 214 may be flushed with a regenerant solution (e.g., a brine solution) provided from the brine tank 204. The regenerant solution may facilitate the release of minerals, including calcium and magnesium, and/or other impurities from the ion exchange resin bed 214. Then, the regenerant solution may carry the minerals and/or other impurities out of the treatment tank 202. These operations, as well as backwash, rinse, and standby operations, may be facilitated by the control valve 206. The control valve 206 may be in communication with a controller which is designed to direct actuation of the control valve 206.

In some instances, the control valve 206 may be provided in the form of a valve body 220 which includes a central bore 224. The control valve 206 may be in fluid communication with the treatment tank 202. In some instances, the control valve 206 may be fluidly coupled to the treatment tank 202 and the brine tank 204. The inlet 208 may be in communication with a source of untreated water, and the outlet 210 may be in communication with a treated water conduit and a drain outlet 212. External ports of the control valve 206 may be fluidly connected to the inlet 208, the outlet 210, the drain outlet 212, the brine tank 204, the treatment tank opening 216, and the distributor pipe 218 of the treatment tank 202. The injector assembly 222 may be designed to draw the regenerant solution from the brine tank 204 and provide the regenerant solution to the treatment tank 202.

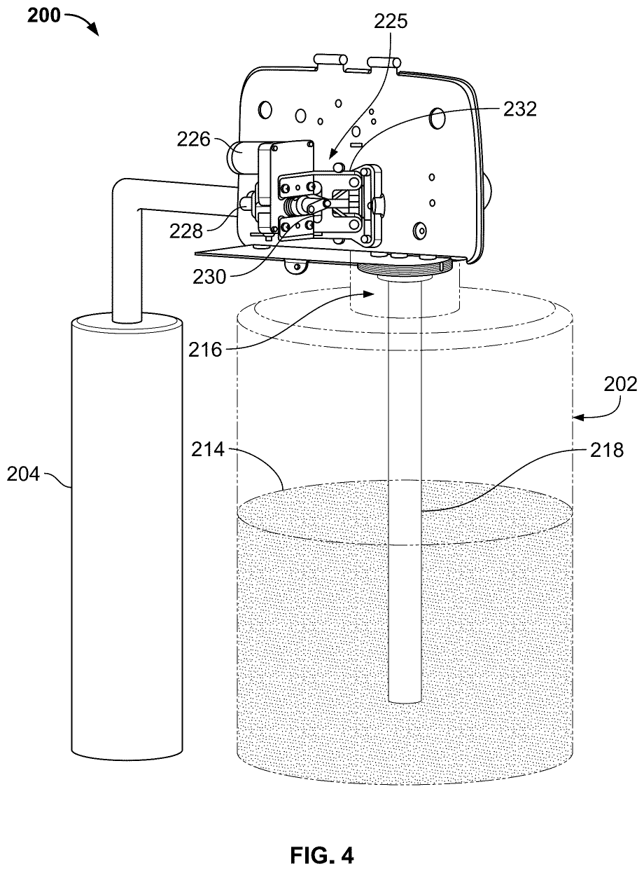

Referring to FIG. 4, the water softener system 200 of FIG. 3 may further include a drive assembly 225 provided in the form of an electric motor 226, a drive shaft 228, an eccentric cam 230, and a cam link 232. The electric motor 226, the drive shaft 228, the eccentric cam 230, and/or the cam link 232 may be provided as part of the control valve 206 or may be in communication with the control valve 206.

In some instances, the central bore 224 of the valve body 220 may be designed to receive a piston assembly (not shown) and a seal assembly (not shown). The piston assembly may include a piston rod coupled to a piston at a first end and a drive assembly 225 at an opposing, second end. An upper shuttle may be received by the piston rod adjacent to the piston to substantially prevent untreated water from flowing to the outlet 210 during the regeneration mode. The upper shuttle may be axially translatable with respect to a first end of the piston. The piston assembly may further include a lower shuttle, adjacent an opposing end of the piston, which may be axially translatable relative to a second end of the piston, which may allow the control valve 206 to enter a standby mode in which there is substantially no flow through the valve body 220. The standby position of the piston assembly may allow the control valve 206 to operate in multi-tank systems without the need for an external solenoid, diaphragm, or other type of valve or a second piston and drive mechanism, which may be required by conventional multi-tank systems.

The drive assembly 225 may be driven by an electric motor 226 coupled thereto. The drive assembly 225 may include the drive shaft 228 coupled to the eccentric cam 230. A cam link 232 may connect the eccentric cam 230 to the piston rod. In some instances, actuation of the electric motor 226 may cause the drive shaft 228 and eccentric cam 230 to rotate. Rotation of the eccentric cam 230 may result in translational movement of the cam link 232 to drive the piston and the piston rod within the central bore 224. In some instances, the various stages or modes of the regeneration cycle may correspond to different rotational positions of the eccentric cam 230 (e.g., a first rotational position, a second rotational position, a third rotational position). The use of an electric motor 226 and eccentric cam 230 is not meant to be limiting and, in other instances, another drive mechanism (e.g., a solenoid, a linear actuator, a stepper motor, a servo motor, etc.) may be utilized to axially translate the piston assembly of the water softener system 200.

The water softener system 200 may include or be in communication with a controller similar to the controller 152 of FIG. 2. The controller may be designed to predict resin breakthrough of the ion exchange resin bed 214 as well as water hardness of water provided to the water softener system 200 utilizing measurements from the ion-selective probe 211. The controller may predict the point of breakthrough of the ion exchange resin bed 214 or the risk of breakthrough by determining a slope of an ion concentration (e.g., measured in ppm) versus the volume of water that has passed through the treatment tank 202 (e.g., measured in liters). In various instances, the controller may determine the slope using the equation y=mx+b, where m is the determined slope, x is the volume of water, y is the divalent or trivalent ion concentration, and b is the y-intercept. In some instances, the controller may predict the point of breakthrough of the ion exchange resin bed 214 or the risk of breakthrough by determining a slope of divalent or trivalent ion concentration (e.g., measured in ppm) versus the volume of water that has passed through the treatment tank 202 (e.g., measured in liters). In various instances, the ion-selective probe 211 may measure the concentration of the divalent or trivalent ions at intervals of about every millisecond, about every second, about every minute, about every 10 minutes, about every 30 minutes, about every hour, about every 24 hours, about every 48 hours, about every 72 hours, about every week, or about every month. In certain cases, the divalent or trivalent ions are calcium ions and/or magnesium ions.

Referring again to FIG. 3, in some instances, the ion-selective probe 211 may measure the divalent or trivalent ions at intervals of about every 1 mL, or about every 50 mL, or about every 100 mL, or about every 250 mL, or about every 500 mL, or about every 1 L, or about every 5 L, or about every 10 L, or about every 20 L, or about every 50 L of water processed by the water softener system 200. A flow sensor may determine the volume of water flowing through the water softener system 200. In some instances, the flow sensor may be positioned within the ion-selective probe 211. Alternatively, the flow sensor may be positioned elsewhere in the water softener system 200, including but not limited to the inlet 208 and the outlet 210. In some such instances, the flow sensor may be electrically coupled to the ion-selective probe 211 and the controller such that the hard water may be tested on a regular basis of water volume.

The controller may collect data from the ion-selective probe 211 and store the data for analysis. The data may comprise information related to the hardness of the treated water and the volume of water produced by the treatment tank 202, including since the last regeneration of the treatment tank 202 and/or at predetermined time intervals. The controller may determine the rate of change of the water hardness value versus the volume of water flowing through the treatment tank 202 (i.e., the slope, as described herein).

Once the slope has been determined, the value of the determined slope may be used in conjunction with at least one threshold value by the controller to determine a subsequent action. For example, when the determined slope is at or below a first threshold value, the controller may determine that the ion exchange resin bed 214 is in normal operating condition and does not need regeneration. Thus, the water softener system 200 may continue operating in the service mode. As an additional example, when the determined breakthrough slope is at or above a second threshold value (but below a third threshold value), the controller may determine that a breakthrough of the resin bed is imminent. When the breakthrough of the ion exchange resin bed 214 is imminent, the controller may provide an alert to the user indicating that the ion exchange resin bed 214 needs regeneration within a defined period in order to help ensure that the water softener system 200 remains functional. As a further example, when the determined breakthrough slope is at or above a third threshold value, the controller may determine that resin breakthrough has occurred. When the controller has determined that resin breakthrough has occurred, the controller may provide an alert to the user that the water softener system 200 is no longer functioning properly and/or the controller may direct the water softener system 200 to enter the regeneration mode.

In some instances, the second threshold value may be defined in relation to the third threshold value. For example, the second threshold value may be imparted with a value of no more than about 85% of the third threshold value. In such instances, the second threshold value may be imparted with a value of at least about 85%, or at least about 90%, or at least about 95%, or at least about 97%, or at least about 99% of the third threshold value. In other such instances, the second threshold value may be imparted with a value of at least 85%, or at least 90%, or at least 95%, or at least 97%, or at least 99% of the third threshold value. In certain instances, the percentage of the second threshold value in comparison to the third threshold value may be somewhat less or greater than the values recited herein. In some instances, the percentage of the second threshold value in comparison to the third threshold value may fall within a range bounded by any minimum value and any maximum value as described above.

In some instances, the first, second, and third threshold values may be determined in real time by the controller and based on measurements obtained by the ion-selective probe 211. For example, the controller may determine the rate of change (i.e., the slope) of the positively charged ion concentration versus the volume of water flowing through the water softener system 200 at predetermined intervals. If a first determined slope is less than or equal to a second determined slope, and a third determined slope is greater than the first and second determined slopes, the controller may determine that resin breakthrough has occurred. As an additional example, if the first determined slope is less than the second determined slope by at least a first predetermined amount, and if the third determined slope is greater than both the first and second determined slopes by more than a second predetermined amount, the controller may then determine that resin breakthrough has occurred. In such instances, the first and second predetermined amounts may be at least about 1 ppm per volume of water, or at least about 5 ppm per volume of water, or at least about 10 ppm per volume of water, or at least about 20 ppm per volume of water, or at least about 30 ppm per volume of water, although the first and second predetermined amounts may be somewhat less or greater than these values. In some such instances, the first and second threshold values may be the same, or the first and second threshold values may be different.

Referring still to FIG. 3, the ion-selective probe 211 may be designed to determine the concentration of divalent and/or trivalent ions (e.g., calcium and/or magnesium ions) in the source water provided to the inlet 208 of the water softener system 200. In various instances, the concentration of divalent and/or trivalent ions in the source water can be determined using look-up tables based on testing for different incoming hardness waters in the range of about 1 grain to about 40 grains. In some instances, the water softener system 200 may generate a fluid with a predetermined, defined water hardness, as measured by the ion-selective probe 211. The defined water hardness may then be communicated to the controller, which associates the defined water hardness value with a comparative value in the look-up table to determine the water hardness of water provided to the inlet conduit. In various instances, the hardness of the water is determined as hardness=slope*x where x is the volume of water.

The determined slope values may at least partially depend on a volume of the ion exchange resin bed 214 utilized in the water softener system 200 and/or on the hardness of the water provided to the water softener system 200. For example, water imparted with a hardness value of 15 grains may have a lower slope value than water imparted with a higher hardness value (e.g., 20 grains, 25 grains).

In many instances, the ion-selective probe 211 may detect at least one ion including calcium, magnesium, barium, aluminum, strontium, iron, zinc, and manganese ions. In other instances, the ion-selective probe 211 may determine ion concentrations in a sample of water, the ions selected from the group consisting of calcium ions, magnesium ions, barium ions, aluminum ions, strontium ions, iron ions, zinc ions, and manganese ions. In each instance, the ion-selective probe may help predict and/or measure the occurrence of breakthrough of the ion exchange resin bed 214 and/or the incoming water hardness.

In some instances, the ion-selective probe 211 may help determine and/or predict the occurrence of breakthrough of the ion exchange resin bed 214 and/or the hardness of water provided to a water softening system (such as a point-of-entry (POE) or point-of-use (POU) water softening system), a water purification system, a water filtration system, a reverse osmosis system, or another type of water conditioning system. Furthermore, the ion-selective probe 211 may help determine and/or predict the occurrence of breakthrough of the ion exchange resin bed 214 and/or incoming water hardness in residential, industrial, or commercial applications.

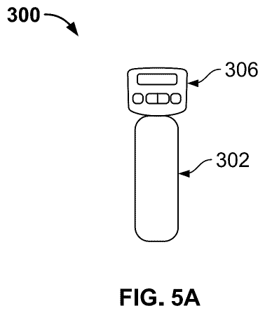

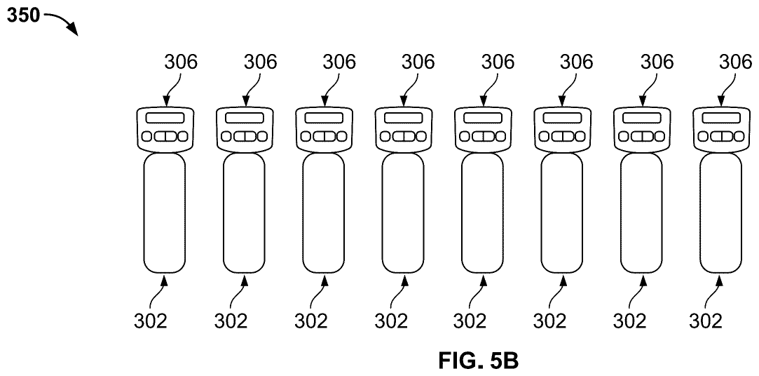

Turning to FIGS. 5A and 5B, a water-softening subsystem 300 may be provided in the form of a treatment tank 302 including a control valve 306 coupled thereto. The treatment tank 302 may have a structure and function substantially similar to the treatment tank 102, as discussed with reference to FIG. 2, and may be utilized as a treatment tank in any of the water softener systems 18, 100, 200 of FIGS. 1-3. The control valve 306 may have substantially the same structure and functionality as the control valve 206 described with reference to FIG. 2. In some instances, the water softener systems 18, 100, 200 of FIGS. 1-3 may include a single-unit water softening system 300 as shown in FIG. 5A. In other instances, the water softener systems 18, 100, 200 of FIGS. 1-3 may include a multi-unit water softening subsystem 350 that includes at least two treatment tanks 302, as shown in FIG. 5B. The treatment tanks 302 in the multi-unit water softening subsystem 350 may be placed in fluid communication with each other via one or more conduits (not shown). The treatment tanks 302 in the multi-unit water softening subsystem 350 may be arranged in series and/or in parallel. In some instances, the multi-unit water softening subsystem 350 may include eight treatment tanks 302, as shown in FIG. 5B. Alternatively, the multi-unit water softening subsystem 350 may also be provided with a different number of treatment tanks 302 than described herein. In some instances, the water softener systems 18, 100, 200 of FIGS. 1-3 may include the multi-unit water softening subsystem 350.

In some instances, one or more of the treatment tanks 302 may be coupled to or in fluid communication with any of the ion-selective probes (e.g., the ion-selective probes 156, 157, 211 of FIGS. 2 and 3) described herein. For example, the ion-selective probe may be in fluid communication with any individual outlet of the treatment tank 302. As an additional example, the ion-selective probe may be in fluid communication with an outlet of the multi-unit water softening subsystem 350 that communicates the combined output of the treatment tanks 302 to an end user.

The treatment tanks 302 may each include a local controller and/or be in communication with a central controller. The local controller and/or the central controller may be designed to predict ion exchange resin bed breakthrough and determine water hardness utilizing measurements from an ion-selective probe, as described with reference to FIG. 2. The local controller and/or the central controller may predict the occurrence and/or the risk of breakthrough by determining a slope of an ion concentration (e.g., measured in ppm) versus the volume of water that has passed through one or more of the treatment tanks 302 (e.g., measured in liters) or the multi-unit water softening subsystem 350 using the techniques described with reference to, for example, FIGS. 2, 15, and 16.

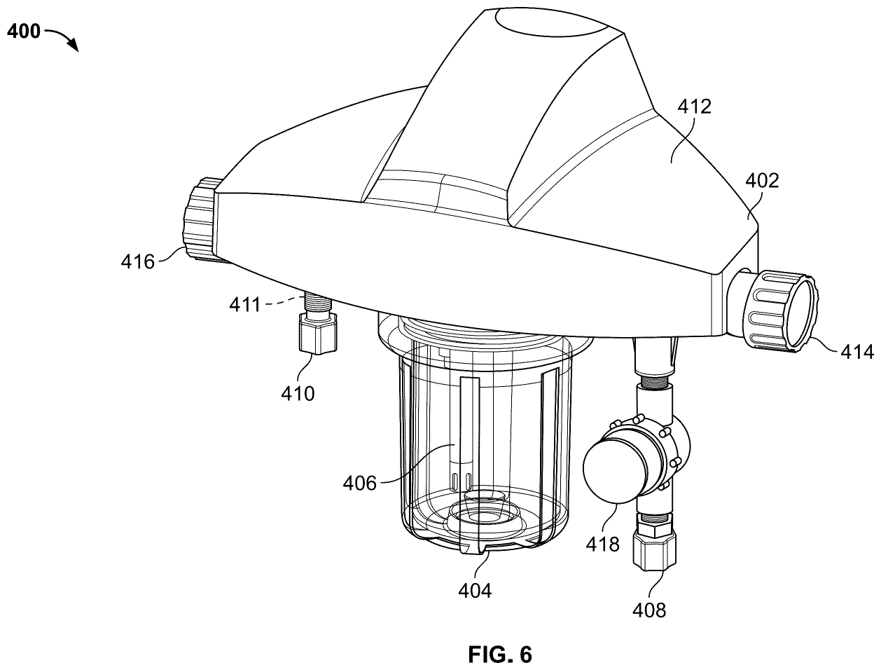

Referring now to FIG. 6, a water quality monitor 400 may include a base 402, a flow cell jar 404, a sensor probe assembly 406, a water inlet 408, a water outlet 410, an optional ion-selective probe 411, a removable cover 412, an inlet flow control valve 414, a water outlet control valve 416, and a debris filter 418. Additional features of the water quality monitor 400 are discussed in U.S. Pat. No. 11,754,545 and U.S. patent application Ser. No. 18/457,308, each entitled “Water Quality Monitor and Method” and filed on Feb. 20, 2020, and Aug. 20, 2023, respectively, the disclosures of which are incorporated by reference herein in their entirety. The water quality monitor 400 may be designed to determine one or more physical and/or chemical parameters of water, including the concentration of various monovalent, divalent, and trivalent ions in the water. Thus, the water quality monitor may be utilized as any of the ion-selective probes discussed herein (e.g., the ion-selective probes 68, 156, 157, 211 as described with reference to FIGS. 1B, 2, and 3). In some instances, the water quality monitor 400 may be in fluid communication with any of the treatment tanks 102, 202, 302 and/or the water softener systems 18, 100, 200 discussed with reference to FIGS. 1A-4.

The base 402 of the water quality monitor 400 may be in communication with an external water source through the water inlet 408 and the water outlet 410. The inlet 408 and outlet 410 may be designed to provide water to and facilitate the flow of water through the water quality monitor 400. The inlet 408 may be in fluid communication with a first pipe connector (not shown) and an inlet flow control valve 414. The outlet 410 may be in fluid communication with a second pipe connector (not shown) and the water outlet control valve 416. In some instances, the debris filter 418 may be provided within the fluid flow path between the inlet 408 and the first side of the base 402. The debris filter 418 may be designed to collect debris in the water, allowing for unimpeded flow of water through the water quality monitor 400. In various instances, the water inlet 408 and the water outlet 410 may protrude from the bottom end of the base 402, although the water inlet 408 and the water outlet 410 may be positioned elsewhere in the water quality monitor 400. In certain instances, the water quality monitor 400 may be placed in-line or otherwise fluidly coupled with any of the water softener systems discussed herein.

In some instances, the base 402 may include a removable cover 412 designed to protect the internal components of the water quality monitor 400 from environmental conditions. The base 402 and the removable cover 412 may comprise any shape, configuration and/or cross section (e.g., the base 402 and the removable cover 412 may be oblong shaped or conically tapered).

The water quality monitor 400 may be designed to direct water to flow through the water inlet 408 to the flow cell jar 404 to be analyzed by the sensor probe assembly 406. The sensor probe assembly 406 may be provided as a single probe that is designed to measure one or more of physical and/or chemical parameters of the water such as a pH value, an oxidation-reduction potential (ORP), a temperature, and combinations thereof. In some instances, the sensor probe assembly 406 may be a single 3-in-1 probe configured to measure the pH, ORP, and water temperature of the water flowing through the system. In yet other instances, the sensor probe assembly 406 may also be designed to measure a concentration of one or more monovalent, divalent, and/or trivalent ions in the water. In various instances, in addition to the sensor probe assembly 406, the water quality monitor 400 may also include the ion-selective probe 411 positioned within the water outlet 410. Alternatively, the ion-selective probe 411 may be in fluid communication with the water inlet 408 or the water outlet 410. The ion-selective probe 411 may be designed to measure a concentration of one or more monovalent, divalent, and/or trivalent ions in the water provided to the water quality monitor 400. In some instances, the ion-selective probe 411 may be a calcium ion-selective probe. In certain cases, the ion-selective probe 411 may have substantially the same structure and function as the first ion-selective probe 156 as described with reference to FIG. 2.

In some instances, the water quality monitor 400 may include or be in communication with a controller that is substantially similar to the controller 152 of FIG. 2. The controller associated with the water quality monitor 400 may be designed to determine the hardness of water provided to a water softening system before the water is softened by utilizing measurements obtained from the sensor probe assembly 406 and/or the ion-selective probe 411. The controller may determine the water hardness by determining a slope of ion concentration (e.g., measured in ppm) versus the volume of water that has passed through the inlet 408 or flow cell jar 404 (e.g., measured in liters).

In various instances, the controller may determine the slope using the equation y=mx+b, where m is the determined slope, x is the volume of water, y is the divalent or trivalent ion concentration (e.g., calcium concentration), and b is the y-intercept. In some instances, the controller may predict the incoming water hardness by determining a slope of divalent or trivalent ion concentration (e.g., measured in ppm) versus the volume of water that has passed through the inlet 408 or flow cell jar 404 (e.g., measured in liters). In various instances the ion-selective probe 411 may measure the divalent or trivalent ions at intervals of about every millisecond, about every second, about every minute, about every 10 minutes, about every 30 minutes, about every hour, about every 24 hours, about every 48 hours, about every 72 hours, about every week, or about every month.

In other instances, the ion-selective probe 411 may measure the calcium ions at intervals of about every milliliter, about every 50 mL, or about every 100 mL, or about every 250 mL, or about every 500 mL, or about every 1 L, or about every 5 L, or about every 10 L, or about every 20 L, or about every 50 L of water processed through a water softener that is in fluid communication with the water quality monitor 400. In some instances, a flow sensor may be provided in or in fluid communication with the water quality monitor 400 to measure volume of water passed through the water quality monitor 400. For example, the flow sensor may be located within or associated with the ion-selective probe 411 as an additional feature of the probe. Alternatively, the flow sensor may be located in other inlet/locations of the water quality monitor 400, including but not limited to inlet 408 and outlet 410. In certain instances, the flow sensor may be provided as part of the sensor probe assembly 406. In some instances, the flow sensor may be in electrical communication with the ion-selective probe 411 and the controller. Thus, the flow sensor may help facilitate testing of the hardness of water provided to a water softening system associated on a regular basis of water volume.

The controller may collect data from the ion-selective probe 411 and store the data for analysis. The data may comprise information related to the hardness of the treated water. The controller may determine the rate of change of the water hardness value versus the volume of water flow through the inlet 408 or flow cell jar 404 (i.e., the slope, as described herein).

The sensor probe assembly 406 and/or the ion-selective probe 411 may also be used to determine the amount of divalent and/or trivalent ions (e.g., calcium ions, magnesium ions) in the source water entering the inlet 408 or flow cell jar 404 of the water quality monitor 400. In various instances, the amount of divalent and/or trivalent ions in the inlet 408 or flow cell jar 404 water can be determined using look-up tables based on testing for different incoming hardness waters in the range of about 1 grain to about 40 grains. In various instances, hardness is determined as hardness=slope*x where x is the volume of water.

The determined slope values may at least partially depend on a volume of the resin bed utilized in the softener system (e.g., the water softener systems 18, 100, 200 of FIGS. 1-4) and/or on the hardness of the water provided to the softener system. For example, the water provided to the softener system imparted with a hardness value of 15 grains may have a lower slope value than incoming water imparted with a higher hardness value (e.g., 20 grains, 25 grains).

In many instances, the ion-selective probe 411 may detect at least one ion including calcium, magnesium, barium, aluminum, strontium, iron, zinc, and manganese ions. In other instances, the ion-selective probe 411 may detect at least one ion to measure and/or predict a hardness value of water provided to the water softener system.

In some instances, the sensor probe assembly 406 and/or the ion-selective probe 411 may help determine and/or predict the hardness of water provided to a water softening system (such as a point-of-entry (POE) or point-of-use (POU) water softening system), a water purification system, a water filtration system, a reverse osmosis system, or another type of water conditioning system. Furthermore, the ion-selective probe 411 may help determine and/or predict the incoming water hardness in residential, industrial, or commercial applications.

In yet other instances, the water quality monitor 400 may be designed to send an alert related to imminent resin bed breakthrough and/or when resin bed breakthrough is occurring in accordance with the processes described with reference to the water softener systems 100, 200 of FIGS. 2-4. In such instances, the water quality monitor 400 may determine the monovalent, divalent, and/or trivalent ion concentration in the treated water produced by a softener system (e.g., the water softener systems 18, 100, 200 of FIGS. 1-4) in order to determine when resin bed breakthrough is imminent or occurring.

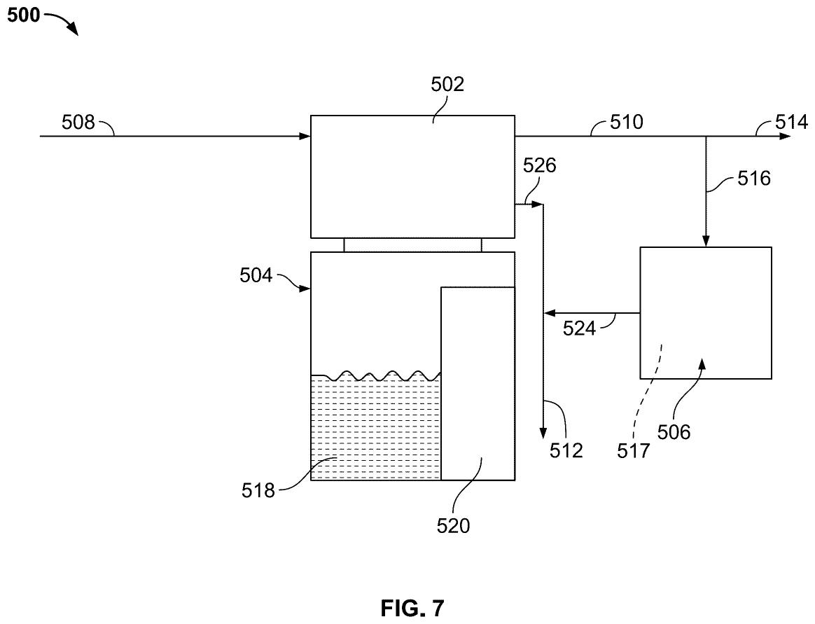

Referring now to FIG. 7, a water softener system 500 may be provided in the form of a treatment vessel 502, a brine tank 504, an electrode assembly 506, an inlet conduit 508, an outlet conduit 510, a drain 512, and a system outlet 514. Components of the water softener system 500 having similar names and/or element numbers as components of the water softener systems 18, 100, 200 of FIGS. 1-4 may have substantially similar structure and function as the components described with reference to the water softener systems 18, 100, 200. In certain instances, the water softener system 500 may be provided as part of the as the home water system 10 described with reference to FIG. 1A. Unlike the water softener systems 18, 100, 200, the water softener system 500 may include a brine well 520 that is retained within the brine tank 504.

The treatment vessel 502 may be designed to soften water provided to the water softener system 500. In some instances, the treatment vessel 502 may be in fluid communication with a valve (not shown) that is designed to control the flow of water to the treatment vessel 502. When the water softener system 500 is operational, hard water may flow into the treatment vessel 502 via the inlet conduit 508. After the water flows through the treatment vessel 502, the water may be provided to the outlet conduit 510 and then to the remainder of the home water system through the system outlet 514.

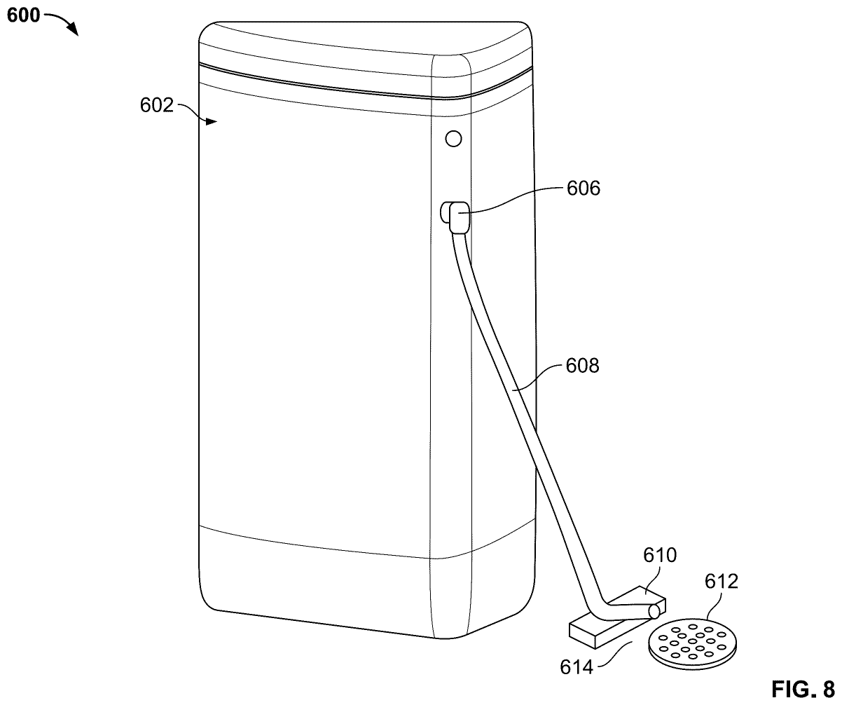

The brine tank 504 may have substantially the same function as the brine tank 140 described with reference to FIG. 2. For example, the brine tank 504 may include a brine solution 518 that may be used to regenerate a resin of the treatment vessel 502. However, unlike the brine tank 140, the brine tank 504 may also include the brine well 520, as further described with reference to FIG. 8.

The electrode assembly 506 may be in fluid communication with the outlet conduit 510, although the electrode assembly 506 may be positioned elsewhere in the water softener system 500. The electrode assembly 506 may include at least one ion-selective probe 517 designed to detect or measure a concentration of monovalent, divalent, and/or trivalent ions. For example, the electrode assembly 506 may include a single ion-selective probe (e.g., the ion-selective probe 517) designed to detect a concentration of calcium ions in the treated water. As an additional example, the electrode assembly 506 may include a first ion-selective probe and a second ion-selective probe in which the first ion-selective probe is designed to detect calcium while the second ion-selective probe is designed to detect magnesium. Thus, the electrode assembly 506 may be designed to determine when breakthrough of a resin of the treatment vessel 502 is imminent or occurring (thereby determining when the resin needs regeneration). In the water softener system 500, aliquots of a predetermined volume of treated water are directed to the electrode assembly 506 through a testing inlet conduit 516 for testing. Alternatively, treated water may flow continuously through the electrode assembly 506. After the monovalent, divalent, and/or trivalent ion concentration of the treated water has been determined, the tested, treated water may be disposed of by exiting the electrode assembly 506 and flowing through a waste conduit 524 before being released to the drain 512. Alternatively, the tested, treated water may be returned to the outlet conduit 510 or otherwise be provided to the system outlet 514.

In some instances, the electrode assembly 506 may use concentrations of a divalent ion and a monovalent ion (e.g., calcium ions and sodium ions) in the treated water to determine an ion differential. In some instances, the ion differential may be represented in units of current, such as millivolts (mV). As previously noted, divalent and trivalent ions contribute to water hardness, and monovalent ions such as sodium and potassium can replace the divalent and trivalent ions in the water, thereby softening the water.

In certain instances, the electrode assembly 506 may determine that resin regeneration is required after evaluating the measured or determined ion differential in association with a predetermined ion differential threshold value. In some instances, the predetermined ion differential threshold value may be imparted with a value of at least about 20 mV to no more than 110 mV. For example, the predetermined ion differential threshold value may be imparted with a value of at least about 10 mV, or at least about 20 mV, or at least about 30 mV, or at least about 40 mV, or at least about 50 mV, or at least about 60 mV, or at least about 80 mV. As an additional example, the predetermined ion differential threshold value may be imparted with a value of no more than about 100 mV, or no more than about 70 mV, or no more than about 50 mV, or no more than about 40 mV, or no more than about 25 mV. In certain instances, the predetermined threshold value may be somewhat less or even greater than the values recited herein. In some instances, the predetermined threshold value may fall within a range bounded by any minimum value and any maximum value as described above.

The resin may be regenerated in response to a determined ion differential that is less than the predetermined ion differential threshold value. The brine tank 504 may be used to regenerate the resin of the treatment vessel 502 by exposing the resin to a brine solution via the brine well 520. The brine well 520 may be adjacent to and at least partially submerged in a brine solution 518. The brine well 520 may provide the brine solution to the resin of the treatment vessel 502 to wash the resin. In some instances, the regeneration may provide a single rinse of the brine solution to the resin. In other instances, the regeneration process may further include steps such as a fast brine rinse, a slow rinse, and a backwash. Depending on the degree of saturation of the resin bed, the regeneration process may be performed iteratively until the electrode assembly 506 determines that the ion differential is substantially equal to or above the predetermined ion differential threshold value. In various instances, the electrode assembly 506 may measure the divalent and monovalent ions (e.g., calcium and sodium ions) in the sampled water at time intervals of about every millisecond, or about every second, or about every minute, or about every 10 minutes, or about every 30 minutes, or about every hour, or about every 24 hours, or about every 48 hours, or about every 72 hours, or about every week, or about every month.

In other instances, the electrode assembly 506 may measure the calcium and sodium ions at intervals of about every milliliter, or about every 50 mL, or about every 100 mL, or about every 250 mL, or about every 500 mL, or about every 1 L, or about every 5 L, or about every 10 L, or about every 20 L, or about every 50 L of water processed through the water softener system 500. In some instances, a flow sensor may be provided with or in fluid communication with the water softener system 500. The flow sensor may be designed to measure the volume of water flowing through the water softener system 500. For example, the flow sensor may be located in inlet and/or outlet locations of the water softener system 500, including but not limited to inlet conduit 508 and outlet conduit 510. In some such instances, the flow sensor may be in electrical communication with the electrode assembly 506 such that incoming hard water may be tested on a regular and/or predetermined basis of water volume.

While the electrode assembly 506 has been described with reference to the water softener system 500 of FIG. 7, it is to be understood that the electrode assembly 506 may also be utilized in any of the water softener systems (e.g., the water softener systems 18, 100, 200 of FIGS. 1-4) described herein. In such instances, the electrode assembly 506 may be used in conjunction with, or in place of, the ion-selective probes provided in the aforementioned water softener systems. It is to be further understood that the electrode assembly 506 may be provided with or in communication with a controller, such as the controller 152 of FIG. 2.

An example brine well 600 is provided in FIG. 8. The brine well 600 may be provided in the form of a tank 602, an overflow fitting 606, a conduit 608, a pedestal 610, and a drain 612. In some instances, the brine well 600 may be utilized as the brine well 520 of FIG. 7. Generally, the brine well 600 may be designed to provide a brine solution to a resin such that the resin can be regenerated. In addition, the brine well 600 may include components designed to dispose of the brine solution in the event that the brine solution overflows the brine well 600. For example, in the event that the brine solution begins to overflow the brine well 600, the brine solution may exit the brine well 600 through the overflow fitting 606 and be passed into the conduit 608. The brine solution may then flow through the conduit 608 and away from the brine well 600 before flowing to an air gap 614. After flowing out of the conduit 608, the brine solution may pass into the drain 612. The air gap 614 may allow for the brine solution to be provided to the drain 612 without directly coupling the brine well 600 to the drain 612, which could increase the risk of a fluid backup from the drain 612.

Turning now to FIGS. 9-14, example data is provided in which the concentrations of various monovalent and divalent ions in water samples associated with a water softener system (e.g., a water softener system 100, 200, 500) were measured using an ion-selective probe (e.g., an ion-selective probe 156, 157, 211, 411). As previously discussed, the ion-selective probe may determine the concentration of various ions (e.g., sodium ions, calcium ions) in water. In addition, a flow sensor may be used to determine the volume of water provided to the water softener system. It is to be understood that any of the processes described with reference to FIGS. 9-14 may be implemented by any of the water softener systems and/or the controllers described herein.

Turning first to FIG. 9, a graph 700 of a calcium ion concentration and a sodium ion concentration in a water sample versus volume of water processed by the softener is provided. The water provided to the water softener system was imparted with a hardness value of 23 grains. The ion concentration in the water may be measured at an outlet of the water softener system versus a volume flow (measured in liters) using an ion-selective probe. As shown in FIG. 9, initially, the concentration of sodium ions is higher than the concentration of calcium ions in the water in the outlet. As the ion exchange resin bed breaks down, the concentration of calcium ions in the treated water increases, eventually becoming greater than the concentration of sodium ions, as indicated by an intersection 702. In the example shown in FIG. 9, breakthrough of the ion exchange resin bed occurs between 100 L and 120 L, or at about 110 L of volume for the water. In addition, FIG. 9 illustrates that the resin breakthrough may be determined by monitoring the concentration of both the calcium ions and the sodium ions in the treated water and determining an ion differential (wherein the ion differential below a threshold value after intersection 704).

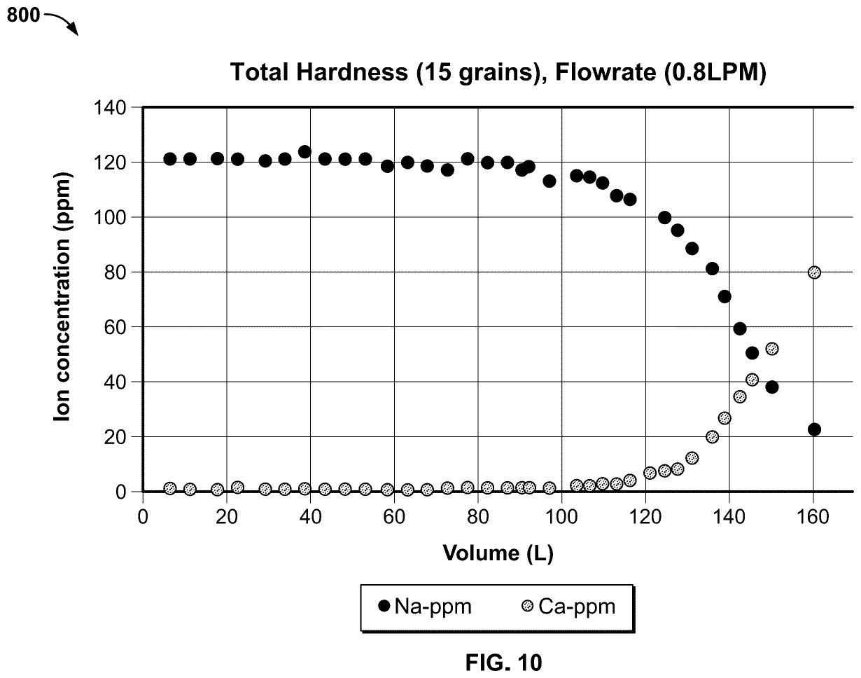

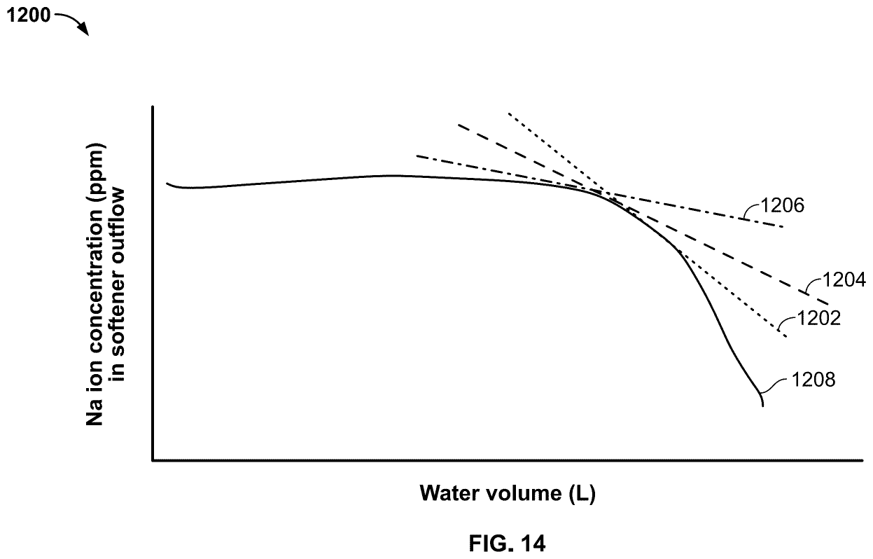

Further examples of determining a breakthrough event are provided with reference to FIGS. 10-14. As shown in FIGS. 10-13, the occurrence of a resin breakthrough event may be determined if a rate of change of the calcium ion concentration versus water volume increases. Such an increase in the rate of change of the calcium ion concentration may occur when an absolute concentration of calcium ions in the water increases. In addition, as explained with reference to FIG. 14, the occurrence of a breakthrough event may be determined if a rate of change of the sodium ion concentration versus water volume increases. Such an increase in the rate of change of sodium ion concentration may occur when an absolute concentration of sodium ions in the water decreases.

Turning to FIG. 10, a graph 800 shows the calcium ion and sodium ion concentrations versus a volume of water processed by a water softener system. The water processed by the water softener system is imparted with a hardness value of 23 grains. The ion concentrations of the water may be measured by an ion-selective probe in fluid communication with an outlet of the water softener system. Initially, the concentration of sodium ions may be higher than the concentration of calcium ions in the treated water. As the ion exchange resin breaks down, the concentration of calcium ions in the treated water increases, eventually becoming greater than the concentration of sodium ions. As shown in FIG. 10, the point at which the ion exchange resin breakthrough occurs is at about 130 L to about 150 L of water, or at about 140 L of volume for water imparted with an incoming hardness of 23 grains.

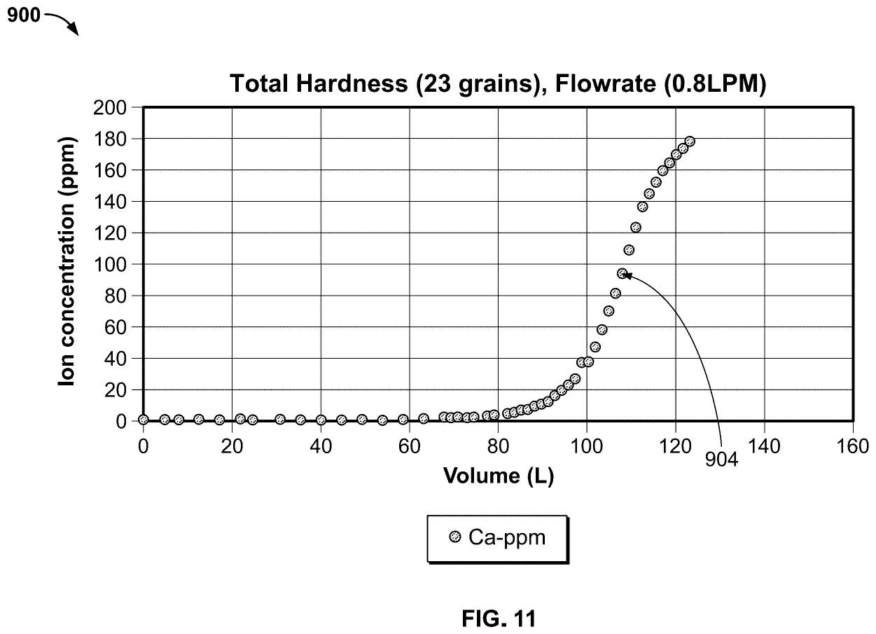

In FIG. 11, a graph 900 shows calcium ion concentrations versus a volume of water processed by a water softener system. The water processed by the water softener system is imparted with a hardness value of 23 grains. The ion concentration of the water may be measured at the outlet of the water softener system using an ion-selective probe. Initially, the concentration of calcium ions is low or substantially undetectable in the treated water. As the ion exchange resin breaks down, the concentration of calcium ions in the treated water increases, eventually reaching an inflection point 904 at a water volume of between 120 and 140 L of water. In some instances, resin breakthrough may be determined with reference to the inflection point 904.

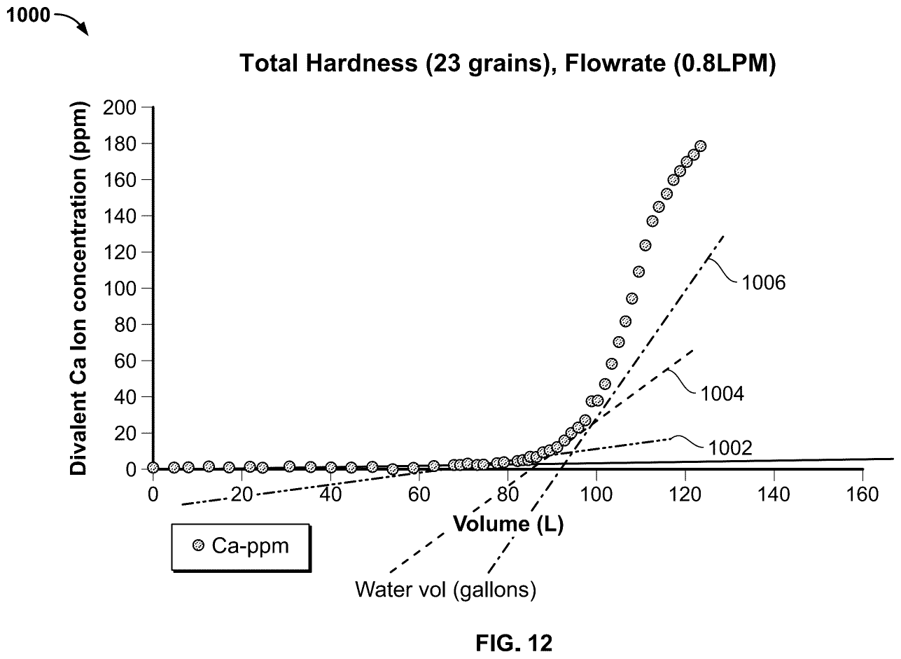

Turning to FIG. 12, a graph 1000 showing calcium ion concentrations versus a volume of water processed by a water softener system is provided. The water provided to the water softener system is imparted with a hardness value of 23 grains. The data further includes a first slope 1002, a second slope 1004, and a third slope 1006 determined using the concentration of calcium ions in a treated water, as measured by an ion-selective probe, versus the volume of water processed by the water softener system. Each of the first, second, and third slopes 1002, 1004, 1006 were determined at a first time period, a second time period, and a third time period, respectively.

The value of the determined slope may be used in conjunction with at least one threshold value by the controller (e.g., any of the controllers discussed herein) to determine a subsequent action. For example, when the determined slope is at or below a first threshold value (e.g., the first slope 1002, as determined at the first time period), the controller may determine that the resin bed is in a normal operating condition and does not need regeneration. Thus, the water softener system 100, 200 may continue operating in the service mode. As an additional example, when the determined breakthrough slope is at or above a second threshold value (but below a third threshold value), the controller may determine that a breakthrough of the resin bed is imminent (e.g., when the determined slope is substantially equal to the second slope 1004, as determined at the second time period). If the breakthrough of the resin bed is imminent, the controller may provide an alert to the user indicating that the resin bed needs regeneration within a defined period to help ensure that the water softener system remains functional. As a further example, when the determined breakthrough slope is at or above a third threshold value, the controller may determine that resin breakthrough has occurred (e.g., when the determined slope is substantially equal to the third slope 1006, as determined at a third time period). By determining the slope values at different time periods and using the determined slopes in conjunction with a predetermined threshold value (e.g., the first, second, and third threshold values), the possibility of a false regeneration cycle being triggered is substantially reduced or eliminated. If the controller determines that resin breakthrough has occurred, the controller may provide an alert to the user that the water softener is no longer functioning properly and/or the controller may direct the water softener system to enter the regeneration mode.

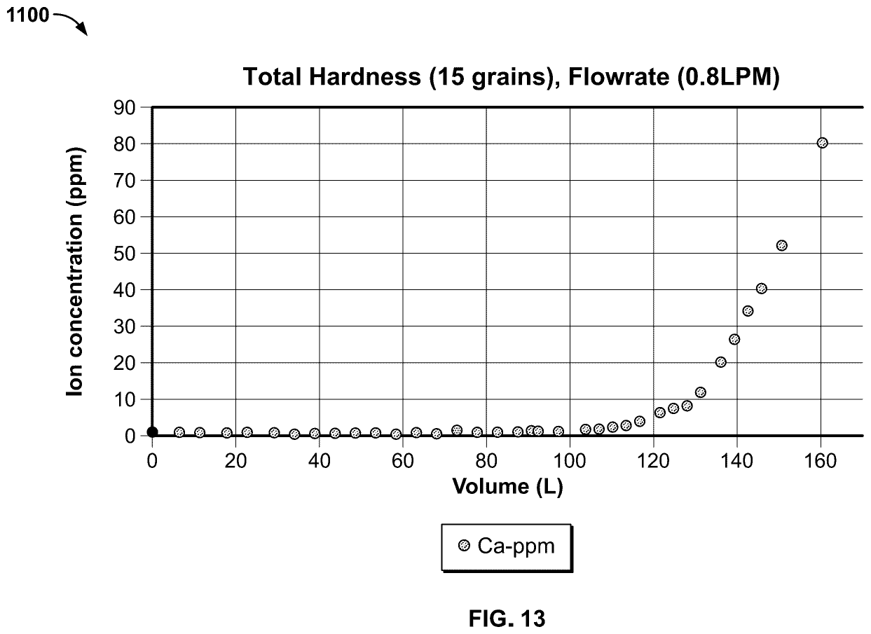

Turning next to FIG. 13, a graph 1100 of calcium ion concentrations versus a volume of water processed by a water softener system is provided. The water provided to the water softener system is imparted with a hardness value of 15 grains. The ion-selective probe may measure the ion concentration at the outlet of the water softener system. The ion concentration may be measured versus the amount of water flowing through the water softener system. Initially, the concentration of calcium ions may be either low or undetectable in the water provided to the outlet of the water softener system. As the ion exchange resin bed breaks down, the concentration of calcium ions in the water of the outlet increases.

FIG. 14 depicts a graph 1200 of sodium ion concentrations versus a volume of water processed by a water softener system. The ion-selective probe may measure the ion concentration of the treated water (i.e., the water softened by the water softener system). The graph 1200 includes a first slope 1202, a second slope 1204, and a third slope 1206 each determined using a sodium ion concentration 1208 versus a volume of water processed by the water softener system. Each of the first, second, and third slopes 1202, 1204, 1206 were determined at a first time period, a second time period, and a third time period, respectively. Slopes utilizing a sodium ion concentration 1208 may be determined using substantially the same techniques as described with reference to the calcium ion concentration; however, unlike the calcium ion concentration (which increases in absolute terms as breakthrough occurs) the measured sodium ion concentration may decrease when resin breakthrough occurs.

Once the slope using the sodium ion concentration 1208 has been determined, the controller (e.g., any of the controllers discussed herein) may use the determined slope in conjunction with at least one threshold value to determine a subsequent action. For example, when the determined slope (e.g., the first slope 1202 as determined at a first time period) is at or below a first threshold value, the controller may determine that the resin bed is in normal operating condition and does not need regeneration. Thus, the water softener system may continue operating in the service mode. As an additional example, when the determined breakthrough slope is at or above a second threshold value, but below a third threshold value, the controller may determine that breakthrough of the resin bed is imminent. For example, the controller may make this determination when the determined slope is substantially equal to the second slope 1204, as determined at the second time period. When the breakthrough of the resin bed is imminent, the controller may provide an alert to the user indicating that the resin bed needs regeneration within a defined period to help ensure that the water softener system remains functional. As a further example, when the determined slope is at or above a third threshold value, the controller may determine that resin breakthrough has occurred (e.g., when the determined slope is substantially equal to the third slope 1206, as determined at a third time period). When the controller has determined that resin breakthrough has occurred, the controller may provide an alert to the user that the water softener is no longer functioning properly. Additionally, the controller may direct the water softener system 100, 200 to enter the regeneration mode.

Turning to FIG. 15, the method 1300 for determining the status of the resin bed of a water softener is provided. The method 1300 may include a step 1302 of providing an ion-selective probe. The method may also include a step 1304 of positioning the ion-selective probe such that the ion-selective probe is in fluid communication with a treated water stream generated by a water softener system. The method 1300 may include a step 1306 of determining a first concentration of ions of the treated water stream using the ion-selective probe. The method 1300 may include a step 1308 of determining, after a predetermined interval, a second concentration of positive ions of the treated water stream using the ion-selective probe. The method 1300 may also include a step 1310 of determining a slope utilizing the first and second concentrations of positive ions. The method 1300 may include a step 1312 of using the slope and a threshold value to determine a subsequent action. If the slope is below the threshold value, the method 1300 may include a step 1314 where no action is taken by the water softener system. If the slope is near the threshold value, the method 1300 may include a step 1316 of creating an alert. If the slope is at or above the threshold value, the method may include a step 1318 of initiating regeneration of the ion exchange resin bed.

In some instances, the step 1304 of positioning the ion-selective probe may include positioning the ion-selective probe at an outlet conduit or outlet. In some instances, the steps 1306 and 1308 may include determining the ion concentration of any of the following ions: calcium, magnesium, aluminum, barium, strontium, iron, zinc, and manganese ions. In many instances, the ion-selective probe used in the step 1306 may measure one or more types of ions selected from the group consisting of calcium ions, magnesium ions, barium ions, aluminum ions, strontium ions, iron ions, zinc ions, and manganese ions. In other instances, the ion-selective probe in the step 1306 may detect at least one divalent or trivalent ion including, by way of example, calcium, magnesium, barium, aluminum, strontium, iron, zinc, and manganese ions to predict and/or measure the occurrence of ion exchange resin bed breakthrough. In some instances, the ion-selective probe used in the step 1306 may measure monovalent ions, e.g., sodium or potassium ions.

One or more steps of the method 1300 may be implemented by a controller. For example, the step 1310 of determining a slope may be implemented by a controller. In some instances, the controller may predict the point of resin bed breakthrough or the risk of breakthrough by determining a slope of calcium concentration (e.g., measured in ppm) versus the volume of water that has passed through the water softener system (e.g., measured in liters).

Referring to FIG. 16, a method 1400 for assessing inlet conduit water hardness based on slope measurements is provided. The method 1400 may include a step 1402 of determining a concentration of ions in the water flowing through an outlet conduit in a water softener system using a single ion-selective probe. The method 1400 may include a step 1404 of evaluating the slope of the concentration of ions over water volume (e.g., the volume of water processed by the water softener system). The method 1400 may include a step 1406 of comparing known slope levels of incoming water hardness (e.g., known slope levels of untreated water provided to the water softener system) to the measured slope. The method 1400 may additionally include a step 1408 of assessing inlet conduit water hardness values based on the slope measurement.

In some instances, the step 1402 of determining a concentration of at least one ion using the ion-selective probe may comprise determining the ion concentration of one or more of the following ions: calcium, magnesium, aluminum, barium, strontium, iron, zinc, and manganese ions. In many instances, the ion-selective probe used in the step 1402 may detect a concentration of a single ion, the ion selected from the group consisting of calcium, magnesium, barium, aluminum, strontium, iron, zinc, and manganese ions. In other instances, the ion-selective probe used in the step 1402 may determine a concentration of divalent or trivalent ions including, but not limited to, calcium, magnesium, barium, aluminum, strontium, iron, zinc, and manganese ions. In such instances, the ion-selective probe may determine the ion concentration to predict and/or measure the incoming water hardness.

In various instances, the concentration of ions (e.g., calcium ions, magnesium ions) in the inlet water can be determined using (1) the slope of the concentration of ions determined in the step 1402 and (2) look-up tables based on testing various source waters imparted with a hardness value in the range of about 1 grain to about 40 grains. In some instances, the one or more threshold values may be stored by the controller. In some instances, treated water produced by the water softener system may have a defined water hardness, which is detected by the ion-selective probe. The treated water hardness may be communicated to the controller, which then associates the value with a comparative value in the look-up table to determine the hardness of the water at the inlet conduit. In various instances, the hardness of the inlet water is determined in the step 1408 using hardness=slope*x, where x is the volume of water. The determined slope values may at least partially depend on a volume of the ion-exchange resin bed utilized in the water-softening system and on the hardness of the incoming water.

In some instances, a method for determining resin breakthrough of a water softener includes the steps of providing a first ion-selective probe and a second ion-selective probe, determining a concentration of the positive monovalent ions and a concentration of positive divalent ions in a treated water stream, and providing a controller in communication with the first ion-selective probe and the second ion-selective probe. Each of the first ion-selective probe and the second ion-selective probe is in fluid communication with the treated water stream generated by the water softener system. The controller determines an ion differential based on the concentration of the positive monovalent ions and the concentration of positive divalent ions and uses the ion differential and a threshold value to determine a subsequent action of the water softener.

In some instances, the positive monovalent ions are selected from the group consisting of sodium and potassium. In certain instances, the second ion-selective probe may also determine a concentration of trivalent ions.

In certain cases, no action is taken by the water softener system when the ion differential is above the threshold value. Alternatively, an alert is generated when the ion differential is near the threshold value. Otherwise, the water softener system is regenerated when the ion differential is at or below the threshold value.

In yet other instances, the ion differential is used in conjunction with a second threshold value and a third threshold value to determine a subsequent action of the water softener. For example, no action is taken by the water softener when the ion differential is above the second threshold value and the third threshold value. As an additional example, an alert is created when the ion differential is at or below the second threshold value but above the third threshold value. As a further example, the water softener system is regenerated when the ion differential is at or below the second threshold value and the third threshold value.

In some cases, the regeneration comprises at least one of a brining step, a rinsing step, and a backwash step.

In certain instances, the method also includes a step of dosing a brine solution when the water softener ion differential is at or below the threshold value, wherein the brine solution includes sodium ions and/or potassium ions.

In certain instances, the threshold value corresponds to a current of no more than about 40 mV. In other instances, the threshold value corresponds to a current imparted with a value of at least about 10 mV to no more than about 110 mV.

It is to be understood that one or more of the values (e.g., a first and second concentration, etc.) associated with the methods described herein, including the methods of FIGS. 15 and 16, may be measured at different time intervals or different time periods. The one or more values may be measured on demand, manually implemented, or at predetermined time periods (e.g., continuously, once a second, once a minute, once a day, once a week, once a month, etc.). Further, it is to be understood that the one or more values associated with any of the methods described herein, including the methods of FIGS. 15 and 16, may be measured more than once. For example, a first measurement of the one or more values may be carried out at a first time period followed by a second measurement carried out at a second time period, where the amount of time that elapses between the first time period and the second time period is determined by the predetermined time interval or another predetermined operational condition, such as a volume of water. In each instance, such measurements may be carried out by one or more measurement devices provided with the water softener systems described herein and then received and stored by a controller.

In addition, the predetermined values, thresholds, ranges, and other information described with reference to any of the methods described herein (e.g., the methods of FIGS. 15 and 16) may be manually implemented or otherwise input into the system. For example, the predetermined threshold values may be manually input into a user interface of the controller 152 of FIG. 2, provided to the controller 152 via a user device, or otherwise associated with and retained by the controller 152.

It is also to be understood that the methods 1300, 1400, and any other methods discussed herein may be utilized with any of the water softener systems 18, 100, 200, 500, and any variations thereof, described herein.

In some instances, one or more of the above methods 1300, 1400, and/or other methods and processes described herein can use machine learning (ML), artificial intelligence (AI), or similar processes, to iteratively train the controller and improve the performance of the system based on one or more feedback parameters, characteristics, or similar information. For example, in some instances, ML/AI can be used to predict an optimal water testing interval or threshold value. In some instances, ML/AI can be used to provide accurate chemical testing and/or predict water hardness trends. Thus, the system can be optimized to reduce fluctuations in the frequency of hardness testing by the electrodes or implement dual testing mechanisms such that testing values can be “checked”. This may reduce the likelihood of false positives and failures of the system to recognize when regeneration must take place.

The present disclosure offers the following technical advantages over existing solutions: (a) an improved detection system for identification of resin breakthrough, or the risk of breakthrough, (b) an improved detection system to determine the hardness of the inlet water, and (c) increased efficiency and improvement in regeneration methods that reduce wastewater production.

While the disclosure has been described above in connection with particular aspects and examples, the disclosure is not necessarily so limited, and that numerous other aspects, examples, uses, modifications and departures from the aspects, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

1. A water treatment system comprising:
a treatment tank provided in the form of:
an inlet in fluid communication with a source of untreated water imparted with a first concentration of positively charged ions;
an outlet designed to provide a treated water from the treatment tank; and
a resin retained within the treatment tank designed to generate the treated water, wherein the treated water is imparted with a second concentration of positively charged ions;
a probe in fluid communication with the outlet of the treatment tank, the probe designed to determine a value of the second concentration of positively charged ions at a first time period; and
a controller in communication with the probe, the controller designed to determine a rate of change associated with measurements of the second concentration of positively charged ions.

2. The water treatment system of claim 1, wherein the controller determines a resin breakthrough status by assessing whether the rate of change of the second concentration of positively charged ions is above, substantially equal to, or below a first threshold value.

3. The water treatment system of claim 2, wherein the controller initiates a regeneration cycle at a second time period after determining that resin breakthrough has occurred.

4. The water treatment system of claim 1, wherein the positively charged ions are selected from the group consisting of calcium ions, magnesium ions, barium ions, aluminum ions, strontium ions, iron ions, zinc ions, and manganese ions.

5. The water treatment system of claim 1, wherein:
the probe is an ion-selective probe, and
the probe measures the second concentration of positively charged ions in the treated water at regular intervals, whereby the regular intervals are determined by a volume of water flowing through the water treatment system.

6. The water treatment system of claim 1, wherein the controller is further designed to:
determine a slope utilizing the first concentration of positively charged ions and the second concentration of positively charged ions, and
determine if the slope is above, substantially equal to, or below a threshold value to determine a subsequent action of the water treatment system.

7. The water treatment system of claim 6, the controller further designed to:
take no action when the slope is below the threshold value,
generate an alert when the slope is near the threshold value, and
initiate regeneration of the water treatment system when the slope is at or above the threshold value.

8. A water softener system, comprising:
a water-treatment vessel designed to remove minerals from water passing through the water-treatment vessel, wherein the water-treatment vessel generates a treated water when the water softener system operates in a service mode;
an outlet conduit in fluid communication with the water-treatment vessel;
an ion-selective probe in fluid communication with the outlet conduit, wherein the ion-selective probe is designed to measure a first ion concentration in the treated water at a first time period and a second ion concentration in the treated water at a second time period; and
a controller in communication with the ion-selective probe, the controller designed to determine whether resin bed breakthrough has occurred based at least partially on the first ion concentration and the second ion concentration.

9. The water softener system of claim 8, wherein:
the ion-selective probe determines a plurality of ion concentrations,
a flow sensor is in fluid communication with the water softener system and in communication with the controller, wherein the flow sensor monitors a volume of water flowing through the water softener system,
the controller determines a slope using the plurality of ion concentrations and the volume of water, and
the controller determines whether resin bed breakthrough has occurred.

10. The water softener system of claim 9, wherein the controller initiates a regeneration cycle upon determining that resin bed breakthrough has occurred.

11. The water softener system of claim 8, wherein the controller initiates a regeneration cycle at a third time period upon determining that resin bed breakthrough has occurred, and the regeneration cycle includes providing a brine solution to the resin bed.

12. The water softener system of claim 8, wherein the controller is designed to initiate a standby mode in which untreated water is provided to the outlet conduit.

13. The water softener system of claim 8, wherein the ion-selective probe measures a concentration of positively charged ions in the treated water at regular intervals, whereby the regular intervals are determined by a volume of water flowing through the water-treatment vessel.

14. A method for determining resin breakthrough of a water softener, comprising:
placing a first ion-selective probe and a second ion-selective probe into fluid communication with a treated water stream generated by the water softener;
determining a concentration of positive monovalent ions and a concentration of positive divalent ions in the treated water stream; and
providing a controller in communication with the first ion-selective probe and the second ion-selective probe, the controller:
determining an ion differential based on the concentration of positive monovalent ions and the concentration of positive divalent ions; and
using the ion differential and a threshold value to determine a subsequent action of the water softener.

15. The method of claim 14, wherein the positive monovalent ions are selected from the group consisting of sodium ions and potassium ions.

16. The method of claim 14 further including steps of:
taking no action when the ion differential is above the threshold value;
generating an alert when the ion differential is near the threshold value; and
initiating regeneration of the water softener when the ion differential is at or below the threshold value.

17. The method of claim 14, further including steps of:
providing a second threshold value and a third threshold value;
taking no action when the ion differential exceeds the second threshold value and the third threshold value;
creating an alert when the ion differential is at or below the second threshold value and above the third threshold value; and
regenerating a resin bed of the water softener when the ion differential is at or below the second threshold value and the third threshold value.

18. The method of claim 17, wherein the regenerating step includes at least one of a brining step, a rinsing step, and a backwash step.

19. The method of claim 14 further including a step of dosing a brine solution when the ion differential is at or below the threshold value, wherein the brine solution includes sodium ions.

20. The method of claim 14, wherein the threshold value corresponds to a current of no more than about 40 mV.
